(19) United States
(12) Patent Application Publication
(10) Pub. No.: US 2026/0115660 A1
(43) Pub. Date: Apr. 30, 2026

(54) GAS DECOMPOSITOIN CATALYST, METHOD OF DECOMPOSING NITROUS OXIDE GAS USING THE SAME, AND SCRUBBER SYSTEM FOR DECOMPOSING NITROUS OXIDE GAS USING THE SAME

(71) Applicant: Samsung Electronics Co., Ltd., Suwon-si (KR)

(72) Inventors: Su Keun Kuk, Suwon-si (KR); Junkyu Kim, Suwon-si (KR); Hyukjae Kwon, Suwon-si (KR); Jongmin Lee, Suwon-si (KR); Mijong Kim, Suwon-si (KR); Hyunsik Kim, Suwon-si (KR); Joonwoo Park, Suwon-si (KR); Hyunwoo Park, Suwon-si (KR); Inchan Baek, Suwon-si (KR); Youhwan Son, Suwon-si (KR)

(21) Appl. No.: 19/360,378

(22) Filed: Oct. 16, 2025

(30) Foreign Application Priority Data
Oct. 25, 2024 (KR) 10-2024-0147901
Jan. 6, 2025 (KR) 10-2025-0001829

(51) Int. Cl. B01D 53/86; B01J 23/00; B01J 23/83; B01J 27/128; B01J 35/30; B01J 35/31; B01J 35/45; B01J 37/00; B01J 37/08

(52) U.S. Cl. CPC B01D 53/8628; B01J 23/002; B01J 23/83; B01J 27/128; B01J 35/31; B01J 35/393; B01J 35/45; B01J 37/0036; B01J 37/08; B01D 2255/2063; B01D 2255/20746; B01D 2255/20753; B01D 2255/2092; B01D 2255/402; B01D 2257/402; B01J 2523/31; B01J 2523/3706; B01J 2523/845; B01J 2523/847

(57) ABSTRACT

A gas decomposition catalyst, a method of decomposing nitrous oxide gas by using the gas decomposition catalyst, and a scrubber system for decomposing nitrous oxide gas by using the gas decomposition catalyst. The gas decomposition catalyst includes a perovskite oxide host material containing a B′ element and represented by Formula 1, and at least one B′ element protruding particle derived from some or all of the B′ element, where the B′ element protruding particle has a shape in which a portion of the particle is fixed inside the perovskite oxide host material and another portion of the particle protrudes from the surface of the perovskite oxide host material:

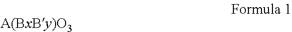

where A, B, B′, x and y in Formula 1 are as described in the detailed description.

### CROSS-REFERENCE TO RELATED APPLICATION

This application is based on and claims priority to Korean Patent Application Nos. 10-2024-0147901, filed on Oct. 25, 2024, and 10-2025-0001829, filed on Jan. 6, 2025 in the Korean Intellectual Property Office, and all the benefits accruing therefrom under 35 U.S.C. § 119, the disclosures of which are incorporated by reference herein in their entirety.

### BACKGROUND

### 1. Field

The disclosure relates to a gas decomposition catalyst, a method of decomposing nitrous oxide gas by using the gas decomposition catalyst, and a scrubber system for decomposing nitrous oxide gas by using the gas decomposition catalyst.

### 2. Description of the Related Art

Nitrous oxide (N₂O) is mainly used for cleaning automobile exhaust gases, semiconductor process gases, or display process gases. In these industries, reduction processes for reducing nitrous oxide (N₂O) emissions are essential to achieve carbon neutrality. Research on decomposition of nitrous oxide (N₂O) is being widely conducted to reduce nitrous oxide (N₂O) emissions.

Methods of decomposing nitrous oxide (N₂O) include thermal decomposition methods using high-temperature heating and direct decomposition methods using a catalyst. According to thermal decomposition methods using high-temperature heating, it is not easy to control heat and energy under high operating temperatures of 1000° C. or higher for decomposition of nitrous oxide (N₂O). Therefore, there is a significant need for the development of a gas decomposition catalyst that is thermally and chemically stable under an operating environment of nitrous oxide (N₂O) decomposition and that has improved nitrous oxide (N₂O) decomposition performance.

### SUMMARY

Provided is a gas decomposition catalyst that is thermally and chemically stable under an operating environment of nitrous oxide (N₂O) decomposition and that has improved nitrous oxide (N₂O) decomposition performance.

Provided is a method of decomposing a nitrous oxide gas using the gas decomposition catalyst.

Provided is a scrubber system for decomposing a nitrous oxide gas using the gas decomposition catalyst.

Additional aspects will be set forth in part in the description which follows and, in part, will be apparent from the description, or may be learned by practice of the presented embodiments of the disclosure.

According to an aspect of the disclosure,
a gas decomposition catalyst includes a perovskite oxide host material containing a B′ element and represented by Formula 1 below, and
at least one B′ element protruding particle derived from some or all of the B′ element,
wherein the B′ element protruding particle has a shape in which a portion of the particle is fixed inside the perovskite oxide host material and another portion of the particle protrudes from the surface of the perovskite oxide host material:

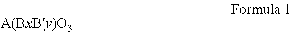

wherein, in Formula 1, A includes lanthanum (La), strontium (Sr), or a combination thereof,
B includes a transition metal having an oxidation number of +3, +4, or +5,
B′ includes an element having a Gibbs free energy of 0 or less for a reduction reaction at 900° C. according to Reaction Formula 1, and

$$0 < x < 1 , 0 < y < 1 , and x + y = 1 :$$

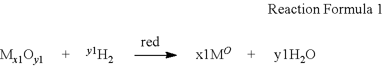

wherein, in Reaction Formula 1, x1 and y1 are each positive rational numbers, “red” refers to the reduction reaction, and M is a metal.

According to another aspect of the disclosure, a method of decomposing a nitrous oxide (N₂O) gas includes contacting a process gas including nitrous oxide with a gas decomposition catalyst to decompose the nitrous oxide (N₂O) gas,
wherein the gas decomposition catalyst includes a perovskite oxide host material containing a B′ element and represented by Formula 1 below, and
at least one B′ element protruding particle derived from some or all of the B′ element,
wherein the B′ element protruding particle has a shape in which a portion of the particle is fixed inside the perovskite oxide host material and the other portion of the particle protrudes from the surface of the perovskite oxide host material:

A(BxB′y)O₃ Formula 1
wherein, in Formula 1, A includes lanthanum (La), strontium (Sr), or a combination thereof,
B includes a transition metal having an oxidation number of +3, +4, or +5,
B′ includes an element having a Gibbs free energy of 0 or less for a reduction reaction at 900° C. according to Reaction Formula 1, and

$$0 < x < 1 , 0 < y < 1 , and x + y = 1 :$$

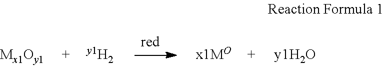

wherein, in Reaction Formula 1, x1 and y1 are each positive rational numbers, “red” refers to the reduction reaction, and M is a metal.

According to another aspect of the disclosure, a scrubber system for decomposing a nitrous oxide gas includes a gas inlet unit through which a process gas including nitrous oxide is introduced,
a scrubber including a gas decomposition catalyst for decomposing a nitrous oxide (N₂O) from the process gas including nitrous oxide introduced from the gas inlet unit to provide a scrubbed gas, and
a gas outlet unit for discharging the scrubbed gas,
wherein the gas decomposition catalyst includes a perovskite oxide host material containing a B′ element and represented by Formula 1 below, and
at least one B′ element protruding particle derived from some or all of the B′ element,
wherein the B′ element protruding particle has a shape in which a portion of the particle is fixed inside the perovskite oxide host material and another portion of the particle protrudes from the surface of the perovskite oxide host material:

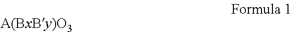

wherein, in Formula I, A includes lanthanum (La), strontium (Sr), or a combination thereof,
B includes a transition metal having an oxidation number of +3, +4, or +5,
B′ includes an element having a Gibbs free energy of 0 or less for a reduction reaction at 900° C. according to Reaction Formula 1, and 0<x<1, 0<y<1, and x+y=1:

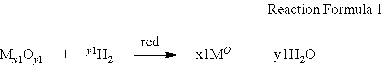

wherein, in Reaction Formula 1, x1 and y1 are each positive rational numbers, “red” refers to the reduction reaction, and M is a metal.

The scrubber may include at least one reactor including a combustion chamber in which the gas including nitrous oxide is introduced from the gas inlet unit and heated, a catalyst chamber in which the gas including nitrous oxide heated from the combustion chamber is heated and introduced to react with a first gas decomposition catalyst to decompose a nitrous oxide (N₂O) gas, and a heat storage chamber in which the gas including nitrous oxide that has reacted with the gas decomposition catalyst is introduced from the catalyst chamber.

The scrubber may include at least one reactor including a combustion chamber in which a process gas including nitrous oxide is introduced from the gas inlet unit and heated, a catalyst chamber in which the process gas including nitrous oxide heated from the combustion chamber is heated and introduced to react with a gas decomposition catalyst to decompose a nitrous oxide (N₂O) gas, and a heat storage chamber in which the process gas including nitrous oxide that has reacted with the gas decomposition catalyst is introduced from the catalyst chamber.

The gas decomposition catalyst may be disposed in the catalyst chamber in a bulk, a molded form, or a layered (bed) form. The scrubber system may have a structure in which two or more of the reactors are arranged in parallel.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A is a view for explaining the formation of B′ element particles exsolved from the inside of a perovskite oxide onto the surface thereof, according to an embodiment;

FIG. 1B is a view for explaining the structure of a perovskite oxide and an exsolved particle in a gas decomposition catalyst according to an embodiment;

FIG. 1C is a view for explaining a structure in which a coating layer containing a B2 element-containing oxide is disposed on the surface of an exsolved particle in a gas decomposition catalyst according to an embodiment;

FIG. 1D is a schematic cross-sectional diagram for comparing the shape of a B′ element particle (B′ element protruding particle) exsolved from the inside of a perovskite oxide host material to the surface thereof with the shape of a B′ particle deposited on the surface of the perovskite oxide host material, according to an embodiment;

FIG. 2 is a view for explaining a method of preparing a gas decomposition catalyst according to an embodiment;

FIG. 3A illustrates a change in N₂O conversion rate (percent, %) with respect to temperature (Celsius, ° C.) in the case of using gas decomposition catalysts according to Examples 1 to 3 and Comparative Example 1 and in the case of using no gas decomposition catalyst according to Comparative Example 2;

FIG. 3B illustrates N₂O conversion rates in the case of using gas decomposition catalysts according to Examples 1 to 3 and Comparative Example 1 and in the case of using no gas decomposition catalyst according to Comparative Example 2;

FIG. 4A illustrates scanning electron microscope (SEM) analysis results for confirming the surface state of a gas decomposition catalyst prepared according to Example 1 after the reduction of the gas decomposition catalyst;

FIG. 4B illustrates is SEM analysis results for confirming the surface state of a gas decomposition catalyst prepared according to Example 2 after the reduction of the gas decomposition catalyst;

FIG. 4C illustrates SEM analysis results for confirming the surface state of a gas decomposition catalyst prepared according to Example 3 after the reduction of the gas decomposition catalyst;

FIG. 4D illustrates SEM analysis results for confirming the surface state of a gas decomposition catalyst prepared according to Comparative Example 1 after the reduction of the gas decomposition catalyst;

FIG. 5 illustrates a change in particle size (nanometers, nm) exsolved from gas decomposition catalysts prepared according to Examples 1 to 3 and Comparative Example 1 with respect to reduction temperature (Celsius, ° C.).

FIGS. 6A to 6D illustrate the results of scanning transmission electron microscopy-energy dispersive spectroscopy (STEM-EDS) analysis of a gas decomposition catalyst prepared according to Example 2;

FIG. 7A illustrates a graph showing strength (arbitrary unit, a.u.) versus angle (2θ, degree) of the results of X-ray diffraction analysis of gas decomposition catalysts prepared in Examples 1 to 3 and Comparative Example 1;

FIG. 7B illustrates a graph showing strength (arbitrary unit, a.u.) versus angle (2θ, degree) of the results of X-ray diffraction analysis of gas decomposition catalysts prepared in Example 1, Examples 4 to 7, and Comparative Example 1;

FIG. 7C illustrates a graph showing strength (arbitrary unit, a.u.) versus angle (2θ, degree) of the results of X-ray diffraction analysis of gas decomposition catalysts prepared in Example 1, Examples 8 to 11, and Comparative Example 1;

FIGS. 8A to 8C illustrate the results of scanning electron microscope (SEM) analysis of the surface state of gas decomposition catalysts prepared according to Example 5, Example 5-1, and Example 5-2, respectively;

FIGS. 9A to 9C illustrate the results of SEM analysis of the surface state of gas decomposition catalysts prepared according to Example 8, Example 8-1, and Example 8-2, respectively;

FIGS. 10A to 10C illustrate the results of SEM analysis of the surface state of a gas decomposition catalysts prepared according to Example 1;

FIG. 11A illustrate the results of high-resolution transmission electron microscopy (HR-TEM) analysis of a gas decomposition catalyst prepared according to Example 4;

FIG. 11B illustrate the results of HR-TEM analysis of a gas decomposition catalyst LaAl_{0.9}Co_{0.05}Fe_{0.05}O₃ (LACF50) prepared according to Example 9;

FIGS. 12A to 12F illustrate the results of SEM-EDS analysis of a gas decomposition catalyst LACN25 prepared according to Example 4;

FIGS. 12G to 12L illustrate the results of STEM-EDS analysis of a gas decomposition catalyst LAC prepared according to Example 1 in comparison with the results of STEM-EDS analysis of a gas decomposition catalyst prepared according to Example 4;

FIGS. 13A to 13F illustrate the results of STEM-EDS analysis of a gas decomposition catalyst LACF25 prepared according to Example 8;

FIGS. 13G to 13L illustrate the results of STEM-EDS analysis of a gas decomposition catalyst LAC prepared according to Example 1 in comparison with the results of STEM-EDS analysis of a gas decomposition catalyst prepared according to Example 8;

FIG. 14 is a graph illustrating N₂O conversion rates (percent, %) with respect to operating temperature (Celsius, ° C.) in a scrubber system for N₂O gas decomposition using a gas decomposition catalyst prepared according to Example 1 and Examples 4 to 7;

FIG. 15A is a graph illustrating N₂O conversion rates (percent, %) at an operating temperature of 800° C. in a scrubber system for N₂O gas decomposition using gas decomposition catalysts prepared according to Examples 3, 4-2, 5-2, 6-2, and 7-2;

FIG. 15B is a graph illustrating N₂O conversion rates (percent, %) at an operating temperature of 800° C. in a scrubber system for N₂O gas decomposition using gas decomposition catalysts prepared according to Examples 3 and 8-2;

FIG. 16 is a schematic diagram illustrating a nitrous oxide (N₂O) gas decomposition system for evaluating the N₂O gas decomposition performance of a gas decomposition catalyst according to an embodiment; and

FIG. 17 is a schematic diagram illustrating a scrubber system for decomposing nitrous oxide (N₂O) gas, according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Since the disclosure can apply various transformations and can have various embodiments, specific embodiments will be illustrated in the drawings and described in detail in the detailed description. However, it should be understood that this is not intended to limit the disclosure to specific embodiments, and includes all transformations, equivalents, and substitutes included in the spirit and technical scope of the disclosure.

The terms used below are used only to describe specific embodiments and are not intended to limit disclosure. An expression used in the singular encompasses the expression of the plural unless it has a clearly different meaning in the context.

The expressions “at least one type,” “one or more types,” “at least one,” or “one or more” preceding components in this specification are intended to supplement the entire list of components and not to supplement the above-described individual components. The term “combination” as used herein includes mixtures, alloys, reaction products, or the like, unless specifically stated otherwise. The term “including” as used herein means that, unless specifically stated otherwise, it may include other components rather than excluding other components. As used herein, the terms “first,” “second,” or the like do not indicate order, quantity, or importance, but are used to distinguish one element from another. Unless otherwise indicated herein or clearly contradicted by context, the singular and plural expressions should be construed to include both. Unless otherwise specified, “or” means “and/or”.

Throughout this specification, the terms “an embodiment,” “embodiments,” and the like mean that a particular element described in connection with an embodiment is included in at least one embodiment described herein and may or may not be present in other embodiments. It should also be understood that the described elements may be combined in any suitable manner in various embodiments.

Unless otherwise stated, all percentages, parts, ratios, or the like are by weight. Additionally, when a quantity, concentration, or other value or parameter is given as either a range, a preferred range, or a list of preferred upper and preferred lower limits, this should be understood to specifically disclose all ranges formed from any pair of any upper range limit or preferred value and any lower range limit or preferred value, regardless of whether ranges are separately disclosed.

When a range of numeric values is mentioned in this specification, unless otherwise stated, the range is intended to include the endpoints thereof and all integers and fractions within the range. It is intended that the scope of the present invention not be limited to the specific values mentioned when defining the scope.

Unless otherwise specified, the unit “parts by weight” means a weight ratio between components, and the unit “parts by weight” means a weight ratio between components converted into solid contents.

As used herein, the term “about” includes the stated value and means within an acceptable range of deviation from a particular value as determined by one of ordinary skill in the art, taking into account the errors associated with that measurement and the measurement of the particular quantity (i.e., limitations of measuring system). For example, “about” could mean within one or more standard deviations, or within ±30%, 20%, 10%, or 5% of a stated value.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by those skilled in the art to which this disclosure belongs. It will also be understood that terms, such as terms defined in commonly used dictionaries, should be interpreted to have a meaning consistent with their meaning in the context of the relevant art and the present disclosure, and not as idealized. Alternatively, these terms should not be interpreted in an overly formal sense.

Embodiments are described herein with reference to cross-sectional views that are schematic diagrams of idealized embodiments. Therefore, the appearance of examples may vary, for example, as a result of manufacturing techniques and/or tolerances. Accordingly, embodiments described herein should not be construed as limited to the specific shapes of the regions described herein, but should include, for example, shape deviations that occur during manufacturing. For example, regions exemplified or described as being flat may typically have rough and/or non-linear features. Additionally, exemplified acute angles may be rounded. Accordingly, regions illustrated in the drawings are schematic in nature and their shapes are not intended to illustrate the precise shape of the regions and are not intended to limit the scope of the present claims.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

As used herein, the term “solid solution” refers to a homogeneous crystal phase containing two or more chemical species, which is different from a mixture of two or more chemical species.

Unless otherwise defined, the term “size” of a particle may refer to “particle diameter” of the particle.

As used herein, the “particle diameter” refers to an average diameter when a particle is spherical, and refers to an average major axis length when the particle is non-spherical. The average particle diameter is a median particle diameter (D50) unless otherwise explicitly stated. Median particle diameter (D50) is a size of the particle corresponding to the cumulative value of 50%, calculated from the side of the particle with the smallest particle size in the cumulative distribution curve of particle sizes in which particles accumulate in order of particle size from the smallest particle to the largest particle. The accumulated value may be, for example, an accumulated volume. The median particle diameter (D50) may be measured, for example, by laser diffraction.

When measuring a particle size using a scanning electron microscope, it is determined as the average value of 30 or more randomly selected particles of 1 micrometers (μm) or more, excluding fine particles.

The average particle diameter may be measured, for example, using a laser diffraction method. More specifically, the particles are dispersed in a solution, introduced into a commercially available laser diffraction particle size measuring device (e.g., Microtrac MT 3000), and ultrasonic waves of about 28 kilohertz (kHz) are irradiated at an output of 60 watts (W). Then, the average particle diameter (D50) based on 50% of the particle diameter distribution in the measuring device may be calculated.

As used herein, the term “thickness” refers to an average thickness.

Hereinafter, a gas decomposition catalyst according to an embodiment, a method of preparing the same, a scrubber system for decomposing nitrous oxide gas using the gas decomposition catalyst, and a method of decomposing nitrous oxide gas using the scrubber system will be described in detail.

Among the methods of decomposing nitrous oxide (N₂O) gas, a method using a catalyst can save energy by operating at a low temperature of about 600° C. to about 800° C., as compared with other methods, such as a thermal decomposition method. As such a catalyst, a zeolite catalyst or a supported catalyst impregnated or co-precipitated with a precious metal on an alumina support may be used. However, the above-described catalyst has low dispersion and, under the operating environment for nitrous oxide (N₂O) decomposition, metal nanoparticles, which are reaction active sites, aggregate and coarsen, or evaporate, thereby deteriorating the performance of nitrous oxide (N₂O) decomposition, and therefore, improvement thereof is required.

### Gas Decomposition Catalyst

A gas decomposition catalyst according to an embodiment of the disclosure is designed to solve the above-described problems, and includes a perovskite oxide host material containing a B′ element and represented by Formula 1 below, and at least one B′ element protruding particle derived from some, all, or substantially all of the B′ element associated with or on a surface of the perovskite oxide host material:

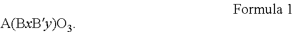

The perovskite oxide host material represented by Formula 1 above has a structure in which the B′ element is substituted at a B site of a general perovskite oxide ABO₃.

The B′ element protruding particles may exist in the form of socket nanoparticles protruding from, or present on, the surface of the host material. When doping the element B′ in various contents at the B site of the perovskite oxide host material represented by Formula 1 above, aggregation of catalyst particles at high temperatures can be prevented, and evaporation can be suppressed, thereby forming a stable gas decomposition catalyst having high gas decomposition efficiency and excellent durability. The size of these nanoparticles may be controlled by the heat treatment temperature performed under reducing conditions in an exsolution reaction for obtaining B′ element protruding particles during the preparation of a gas decomposition catalyst. The gas decomposition efficiency may be controlled depending on the size of the nanoparticles.

In Formula 1, A may include lanthanum (La) or strontium (Sr), and for example, A may be lanthanum (La). As another example, A may be La₁₋ₐSrₐ (0<a<1).

In Formula 1, B may include a transitionmetal having an oxidation number of +3, +4, or +5. B may include, for example, aluminum (Al), titanium (Ti), iron (Fe), chromium (Cr), niobium (Nb), molybdenum (Mo), barium (Ba), tantalum (Ta), or a combination thereof.

In Formula 1, B′ may include an element having a Gibbs free energy

$$( {Δ G}_{red}^{900 C .} )$$

of 0 or less for a reduction reaction at 900° C. according to Reaction Formula 1:

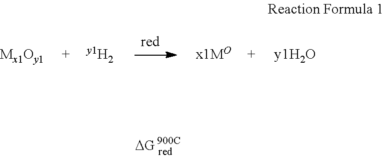

where in Reaction Formula 1, x1 and y1 may each be positive rational numbers, and
M may be a metal. For example, M may include a transition metal having an oxidation number of +3, +4, or +5.

In Reaction Formula 1 “red” refers to the reduction reaction.

The unit of Gibbs free energy is, for example, joule (J).

According to Reaction Formula 1, B′ refers to an element that undergoes a spontaneous reduction reaction at 900° C., and the B′ element in the host material (ABO₃) may be spontaneously reduced and exsolved in a reducing atmosphere of 900° C. Here, the reducing atmosphere can include hydrogen and an inert gas, for example an atmosphere of H₂/Argon (Ar) (5/95, (volume per volume (v/v)).

In an embodiment, the perovskite oxide host material of Formula 1 may comprise a compound represented by Formula 2:

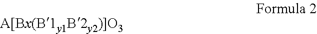

wherein, in Formula 2, A is lanthanum,
B is aluminum,
B′1 is cobalt,
B′2 is at least one of nickel, iron, copper, manganese, rhodium, palladium, iridium, platinum, or gold, and

$$0.5 \leq x < 1 , 0 < ( y 1 + y 2 ) \leq 0 \text{.5} ,$$

$$0 \leq y 1 \leq 0.5 , 0 \leq y 2 \leq 0.5 , x + y 1 + y 2 = 1 ,$$

provided that both y1 and y2 are not 0, and both y1 and y2 are not 0.5.

According to Reaction Formula 1, B′ forms at least one protruding particle derived from some, all, or substantially all of the B′ element associated with, or on the surface of the perovskite oxide host material. In an embodiment, few, or no particles are simply on the surface of the perovskite oxide host material; rather, the particles protrude from the surface.

Specifically, the B′ element protruding particle has a shape in which a portion of the particle is fixed inside the perovskite oxide host material and the other portion of the particle protrudes from the surface of the perovskite oxide host material. More specifically, the B′ element protruding particle has a shape in which a portion of the particle is embedded in the inside of the host material and another portion is exposed on the surface of the host material.

The B′ element may include at least one of cobalt (Co), nickel (Ni), iron (Fe), copper (Cu), manganese (Mn), rhodium (Rh), palladium (Pd), iridium (Ir), platinum (Pt), or gold (Au). The B′ element may be, for example, cobalt (Co), nickel (Ni), iron (Fe), a cobalt-nickel alloy, a cobalt-iron alloy, or a combination thereof.

According to another embodiment, the B′ element protruding particle may include cobalt (Co), nickel (Ni), a cobalt-nickel alloy, a cobalt-iron alloy, or a combination thereof.

The cobalt-nickel alloy is a compound represented by Co_{y1}Ni_{y2}, and the cobalt-iron alloy is a compound represented by Co_{y1}Fe_{y2}, where 0<(y1+y2)≤0.5, 0<y1≤0.5, and 0<y2<0.5.

In the cobalt-nickel alloy (Co_{y1}Ni_{y2}) and the cobalt-iron alloy (Co_{y1}Fe_{y2}), y2 is 0.025 to 0.1, and specifically, y2 is 0.025, 0.05, 0.075, or 0.1. Further, y1 is 0.4 to 0.475, and specifically y1 is 0.4, 0.425, 0.45, or 0.475.

Although not being limited by theory, when the B′ element is cobalt (Co), cobalt has excellent N₂O adsorption properties. The reason for this is that, for example, cobalt reacts with oxygen to form a stable Co₃O₄ spinel structure. Further, when the B′ element is nickel (Ni), N₂O decomposition ability is excellent due to redox properties.

When the B element is a cobalt-nickel alloy, the gas decomposition efficiency of the gas decomposition catalyst can be further improved because the B element contains cobalt, which has excellent N₂O adsorption characteristics, and nickel, which has excellent N₂O decomposition characteristics.

In addition, a coating layer containing a B′ element oxide exists on the surface of the B′ protruding particles. These coating layers may be formed in the presence of air or oxygen. The presence of the coating layer containing such an oxide can improve oxygen mobility and further enhance gas decomposition ability. In an embodiment, the coating layer is formed on the exposed portion of the protruding particles.

The N₂O decomposition mechanism on the surface of the catalyst may be largely divided into two types.

First, there is a decomposition of an N—O bond in N₂O (Reaction Formula 2 below), and second, there is a reaction in which two O atoms are bonded to each other and desorbed into O₂ (Reaction Formula 3 below). The N₂O decomposition ability can be further improved because the second process is accelerated when oxygen mobility is improved.

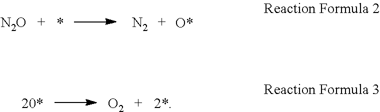

Specifically, a coating layer containing cobalt nickel oxide and/or cobalt iron oxide may be formed on the surface of the cobalt nickel alloy and/or the cobalt iron alloy, respectively.

The B′ element protruding particle may have a socket shape, a spherical shape, an elliptical shape, a ring shape, or a cylindrical shape. For example, the B′ element protruding particle may have a spherical or nearly spherical shape.

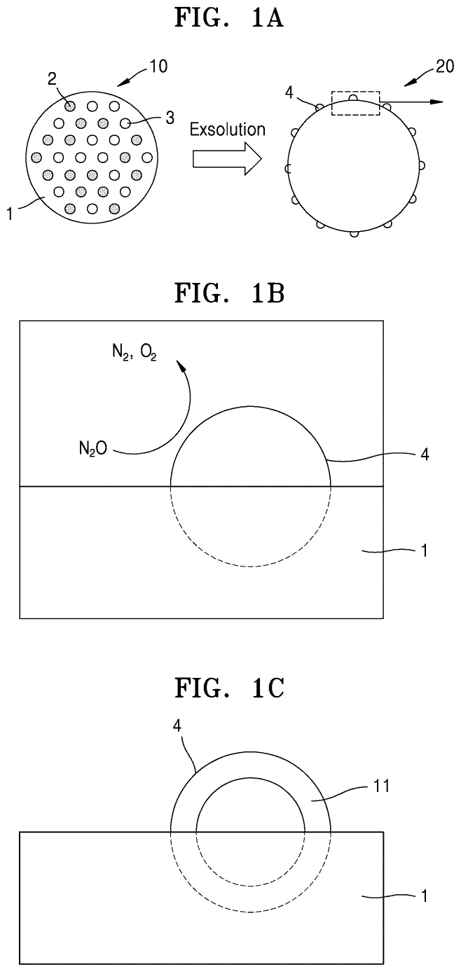

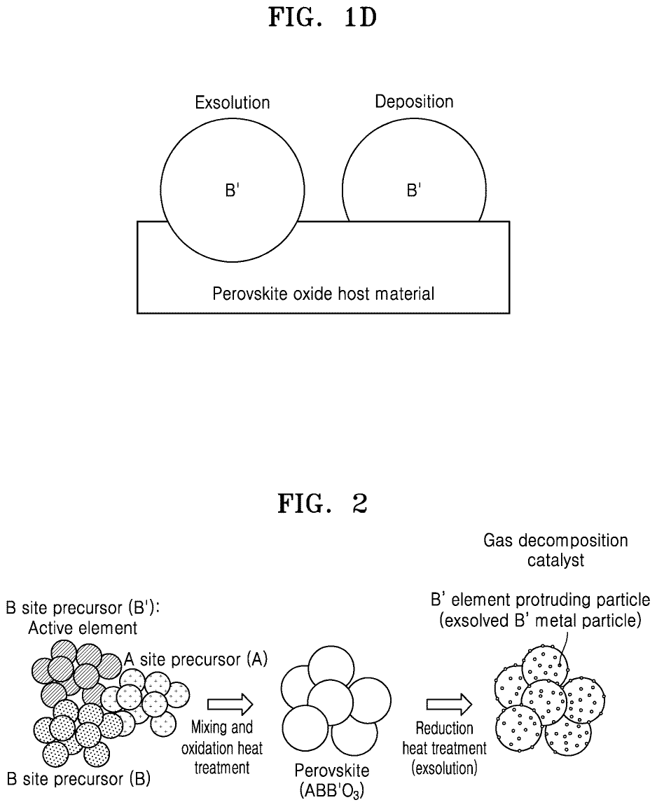

FIG. 1A is a view for explaining the formation of B′ element particles (B′ element protruding particles) exsolved from the inside of a perovskite oxide host material onto the surface thereof according to an embodiment.

As shown in FIG. 1A, a gas decomposition catalyst 20 according to an embodiment may form a gas decomposition catalyst by forming at least one B′ element protruding particle derived from some, all, or substantially all of the B′ element protruding from or on the surface of a perovskite oxide host material through an exsolution reaction of a perovskite oxide solid solution 10 represented by Formula 1 above. The exsolution reaction may be carried out, for example, through reduction heat treatment, and the B′ element inside the perovskite oxide lattice moves to the surface thereof by a reduction reaction (electron transfer) to form B′ element protruding particles.

The perovskite oxide solid solution 10 represented by Formula 1 above has a structure in which the perovskite oxide host material (ABO₃) 1 is doped with a first B′ element 2 and a second B′ element 3. In FIG. 1A, two types of B′ elements, the first B′ element 2 and the second B′ element 3, are used, but one type of B′ element may be used.

FIG. 1B is an enlarged view of a portion of FIG. 1A, showing the structure of a perovskite oxide and a B′ element protruding particle.

Referring to FIG. 1B, the B′ element protruding particle 4 has a structure in which a portion of the particle is embedded in the internal region of the perovskite oxide host material (ABO₃) 1 and another portion of the particle protrudes from the surface in the form of an exsolved particle.

As shown in FIG. 1C, the B′ element protruding particle may have a coating layer 11 including a B′ element oxide on its surface. A coating layer including the above-described B′ element oxide may be formed in an oxidizing atmosphere. The coating layer has a thickness of, for example, about 1 nanometers (nm) to about 5 nm, about 1 nm to about 3 nm, or about 2 nm to about 3 nm. The presence of the coating layer containing an oxide and the thickness of the coating layer may be evaluated by HR-TEM. The presence of such a coating layer can increase oxygen mobility and further improve gas decomposition performance.

FIG. 1D is a schematic cross-sectional diagram for comparing the shape of a B′ element particle (B′ element protruding particle) exsolved from the inside of a perovskite oxide host material to the surface thereof with the shape of a B′ particle deposited on the surface of the perovskite oxide host material according to an embodiment.

Referring to FIG. 1D, the B′ element protruding particle maintains a spherical shape in which a portion of the particle is embedded into the perovskite oxide host material and the other portion of the particle protrudes from the surface thereof. The B′ element protruding particles having such a shape can maintain the number and distribution of particles even after high-temperature heat treatment. Here, the high temperature refers to a temperature of 500° C. or higher, 600° C. or higher, or 800° C. or higher.

In comparison, the shape of the B′ particles deposited on the surface of the perovskite oxide host material may be configured such that a portion thereof can be attached to the surface of the perovskite oxide, but interaction with the host material is insufficient, so that the particles may coarsen on the host material during a particle growth reaction, which may deteriorate the performance of the gas decomposition catalyst.

Therefore, the gas decomposition catalyst including B′ element protruding particles according to an embodiment may be used in industrial fields involving high-temperature catalytic reactions of 800° C. or higher, for example, in electrochemical applications (hydrogen fuel cells (SOFC), protonic ceramic fuel cells, alkaline water electrolysis, or the like).

The B′ element protruding particles may be nanoparticles.

For example, the B′ element of the B′ element protruding particle may comprise cobalt (Co), nickel (Ni), or iron (Fe).

The size of the gas decomposition catalyst may be about 5 nm to about 50 nm, about 5 nm to about 45 nm, about 10 nm to about 45 nm, or about 10 nm to about 25 nm. The size of the B′ element protruding particle may be about 5 nm to about 20 nm, about 5 nm to about 15 nm, or about 5 nm to about 10 nm. When the size of the gas decomposition catalyst and the size of the B′ element protruding particle are within the above ranges, excellent stability and improved gas decomposition efficiency can be realized.

The standard deviation of the size of the B′ element protruding particles may be ±2.0 nm or ±0.9 nm. The above B′ element protruding particles have a nanoparticle size and a uniform distribution.

In this specification, the “size” of a B′ element protruding particle is defined as follows according to the cross-sectional shape of the particle. For example, when the cross-section of a particle is “circular”, such as a sphere, ring, or cylinder, “size” means “diameter.” For example, when the cross-section of a particle is “elliptical”, “size” means “length of a major axis”.

For example, the size of the B′ element protruding particle may be about 5.1 nm to about 19.9 nm, about 5.5 nm to about 19.5 nm, about 6.0 nm to about 19.0 nm, about 6.5 nm to about 18.5 nm, or about 7.0 nm to about 18.0 nm.

The size of the B′ element protruding particles may be measured using grazing-incidence small-angle X-ray scattering (GISAXS). When analyzing the particle size of a gas decomposition catalyst, for example, the particle size of a perovskite oxide, the particle size thereof may be measured using a particle size analyzer or from a TEM photograph or SEM photograph. Alternatively, the particle size thereof may be obtained by measuring particles sizes using a measuring device using performing data analysis for the measured particle sizes, counting the number of particles for each particle size range, and then calculating the results.

The density of the B′ element protruding particles may be about 25 per square micrometers (/μm²) to about 1000/μm².

The density of the B′ element protruding particles may be, for example, about 40/μm² to about 800/μm², or about 50/μm² to about 700/μm². Here, μm² is a unit of the surface area of the host material, and “number,” e.g., 25, 1000, or the like represents the number of B′ element protruding particles. The density of B′ element protruding particles may be evaluated using a scanning electron microscope. When the density of the B′ element protruding particles of the gas decomposition catalyst is within the above range, active sites increase, and thus a gas decomposition efficiency can be improved. The density of the B′ element protruding particles of gas decomposition catalyst may vary depending on the composition of the gas decomposition catalyst and the heat treatment temperature under reduction conditions during the manufacture of the gas decomposition catalyst.

In the gas decomposition catalyst according to an embodiment, a coating layer including a B′ element-containing oxide may be disposed on the surface of the B′ element protruding particle. Here, the volume of protruding or entirety B′ element protruding particles per area of the coating layer containing B′ element oxide is about 0.1 cubic nanometers per square nanometers (nm³/nm²) to about 1.0 nm³/nm², about 0.1 nm³/nm² to about 0.8 nm³/nm², or about 0.15 nm³/nm² to about 0.7 nm³/nm². When the volume of B′ element protruding particles per area of B′ element oxide is within the above range, a gas decomposition catalyst having improved gas decomposition performance while having high particle density and improved stability can be manufactured.

According to an embodiment, the content of B′ element in the B site of the gas decomposition catalyst, that is, the content of B′ element with respect to 100 atom percent (at %) of a total of B element and B′ element, may be more than 0 at % and 50 at % or less, about 1 at % to about 40 at %, about 1 at % to about 30 at %, about 1 at % to about 20 at %, or about 1 at % to about 10 at %, about 3 at % to about 30 at %, about 5 at % to about 20 at %, about 5 at % to about 15 at %, or about 8 at % to about 12 at %.

The gas decomposition catalyst may include, for example, La(Al_{0.9}Co_{0.1})O₃, LaAl_{0.9}Co_{0.075}Ni_{0.025}O₃, LaAl_{0.9}Co_{0.05}Ni_{0.05}O₃, LaAl_{0.9}Co_{0.025}Ni_{0.075}O₃, LaAl_{0.9}Ni_{0.1}O₃, LaAl_{0.9}Co_{0.075}Fe_{0.025}O₃, LaAl_{0.9}Co_{0.05}Fe_{0.05}O₃, LaAl_{0.9}Co_{0.025}Fe_{0.075}O³, LaAl_{0.9}Fe_{0.1}O₃, or a combination thereof.

The gas decomposition catalyst according to an embodiment may be a catalyst capable of decomposing a nitrous oxide (N₂O) gas.

A method of forming a gas decomposition catalyst according to another embodiment may including the processes of preparing a precursor material for a perovskite oxide host material represented by Formula 1 above doped with different B′ elements at the B site, heat-treating the precursor material under oxidizing conditions to obtain a perovskite oxide solid solution, and heat-treating the perovskite oxide solid solution under reducing conditions to provide the gas decomposition catalyst including the B′ element protruding particle.

The heat treatment under the reducing conditions may include, for example, a process of heat-treating the perovskite oxide solid solution at a temperature of about 600° C. to about 1000° C. or about 700° C. to about 900° C. in a reducing gas atmosphere. Here, the reducing gas may be, for example, hydrogen.

In another embodiment, the heat treatment under reducing conditions may be performed using a reducing agent such as sodium borohydride.

The process of obtaining the perovskite oxide solid solution may include a process of pulverizing a mixture of a precursor of A element, a precursor of B element, and a precursor of B′ element to prepare a forming body, and a process of performing an oxidation heat treatment on the forming body at a temperature.

The process of pulverizing a mixture of a precursor of element A, a precursor of B element, and a precursor of B′ element to prepare a forming body may include a process of milling and drying the mixture to obtain dry precursor powder, and a process of pelletizing the dry precursor powder.

The forming body may be a pellet prepared through the above-described pelletizing process. As described above, when preparing the forming body and then performing an oxidation heat treatment on the forming body, a perovskite oxide solid solution having excellent crystallinity can be obtained.

The milling may be performed using, for example, ball milling. Further, the milling may be performed by wet milling in the presence of an organic solvent such as ethanol. In this way, when pulverizing the mixture using an organic solvent, a drying process may be performed to remove the organic solvent, and then a subsequent process may be performed.

The heat treatment under oxidizing conditions may be performed at a temperature of about 800° C. to about 1500° C., about 900° C. to about 1450° C., or about 1000° C. to about 1400° C. in an oxidizing gas atmosphere.

The oxidizing gas atmosphere may be, for example, an oxygen or air atmosphere. Heat treatment time varies depending on heat treatment temperature, but the heat treatment may be performed for, for example, about 1 hour to about 60 hours, about 5 hours to about 30 hours, or about 5 hours to about 10 hours. When heat treatment is performed under the above-described conditions, a perovskite oxide solid solution having excellent stability can be prepared.

In the method of preparing a gas decomposition catalyst according to an embodiment, active element B′ protruding particles may be evenly formed protruding from the surface of a perovskite oxide host material through heat treatment under reducing conditions. The active element B′ protruding particle has a shape in which a portion of the particle is fixed inside the host material and the other portion of the particle protrudes from the surface of the host material. The active element B′ protruding particles may form socket-shaped nanoparticles protruding from or on the surface of the host material.

Therefore, the gas decomposition catalyst prepared by the method of preparing a gas decomposition catalyst according to an embodiment is thermally and chemically stable under an operating environment for nitrous oxide (N₂O) decomposition, has high durability, and has improved nitrous oxide (N₂O) decomposition performance.

FIG. 2 is a schematic view illustrating a method of preparing a gas decomposition catalyst according to an embodiment.

Referring to FIG. 2, the process of obtaining the perovskite oxide solid solution (perovskite (ABB′O₃)) includes mixing a precursor of the A element, a precursor of the B element, and a precursor of the B′ element (active element) to obtain a mixture, and heat-treating the mixture under oxidizing conditions in an air atmosphere and then performing reduction heat treatment to form at least one B′ element protruding particle derived from some or all of the B′ element on the surface of the perovskite oxide, thereby preparing a gas decomposition catalyst.

The precursors of the A element, the B element, and the B′ element may be each a nitrate, a sulfate, an oxalate, a phosphate, an acetate, a carbonate, a citrate, a phthalate, a perchlorate, a hydroxide, an alkoxide, a halide, an oxyhalogenide, an oxide, a peroxide, or a hydrate thereof of each element, or a combination thereof may be used.

For example, the A element may be strontium (Sr) or lanthanum (La), and for example, the A element may be strontium (Sr).

For example, the B element may be a transition metal having an oxidation number of +3, +4, or +5, and may include at least one of, for example, titanium (Ti) and aluminum (Al).

For example, the B′ element may include at least one of cobalt (Co), nickel (Ni), iron (Fe), copper (Cu), manganese (Mn), rhodium (Rh), palladium (Pd), iridium (Ir), platinum (Pt), or gold (Au).

The precursors of the A element, the B element, and the B′ element may be each independently one of a nitrate, a sulfate, an oxalate, a phosphate, an acetate, a carbonate, a citrate, a phthalate, a perchlorate, a hydroxide, an alkoxide, a halide, an oxyhalogenide, an oxide, a peroxide, or a hydrate thereof of each element.

Water may be used as a solvent for mixing the precursor of the A element, the precursor of the B element, and the precursor of the B′ element (active element), but the disclosure is not limited thereto. Any solvent capable of dissolving or dispersing the precursor of each element may be used without limitation. For example, alcohol solvents such as methanol, ethanol, propanol, and butanol; acid solvents such as nitric acid, hydrochloric acid, and sulfuric acid; and organic solvents such as toluene, benzene, acetone, diethyl ether, and ethylene glycol may be used alone or in combination of two or more.

The mixing of the precursor of each element with the solvent may be performed at a temperature of about 25° C. to about 300° C., about 25° C. to about 200° C., or about 25° C. to about 100° C., and may be performed for a preset time under stirring so that each component can be sufficiently mixed to obtain a mixture. Additives, or the like may be added to the mixture.

The mixture may be heat-treated under oxidizing conditions at a temperature of about 800° C. to about 1500° C. or about 900° C. to about 1400° C. in an air atmosphere to obtain a perovskite oxide solid solution. The oxidation condition may be carried out in an oxidizing gas atmosphere, and the oxidizing gas atmosphere may be, for example, an air or oxygen atmosphere.

The heat treatment may be performed within the above-described temperature range for about 1 hour to about 60 hours, for example, about 5 hours to about 30 hours, to obtain a perovskite oxide solid solution. Through this oxidation heat treatment process, the B′ element derived from some or all of the precursors of the B′ element may be solid-dissolved in the form of cations inside the perovskite oxide host material.

Thereafter, the perovskite oxide solution may be ground or pulverized as needed to obtain a fine-sized powder-like perovskite oxide solid solution. The pulverizing method is not limited, but may be selected from ball milling, airjet milling, bead milling, roll milling, hand milling, high-energy ball milling, planetary milling, stirred ball milling, vibration milling, mechanofusion milling, shaker milling, attritor milling, disk milling, shape milling, nauta milling, nobilta milling, or high-speed mixing. The specific surface area of the fine-sized powder-like perovskite oxide solid solution may increase to improve an efficiency of a gas decomposition catalyst.

Next, the perovskite oxide host solid solution is heat-treated under reducing conditions to form at least one B′ element protruding particle derived from some or all of the B′ element the surface of the perovskite oxide host material, thereby preparing a gas decomposition catalyst.

The heat treatment may be performed at about 600° C. to about 1000° C. or about 700° C. to about 900° C.

The B′ element protruding particles may be reduced particles (exsolved B′ metal particles) formed by exsolution from the inside of the perovskite oxide host material to the surface thereof.

Some or all of the reduced particles (exsolved B′ metal particles) formed through reduction heat treatment may be embedded into the perovskite oxide host material in an amount of about 50% or less, about 40% or less, about 30% or less, or about 1% to about 30% of the total volume of the host material. Due to this, the gas decomposition catalyst according to an embodiment is strongly adhered to the surface of the perovskite oxide host material, so that this gas decomposition catalyst has not only very high thermal and chemical stability but also excellent durability.

The heat treatment under reducing conditions may be performed under an atmosphere selected from 1% to 100% H₂ gas, H₂/Ar mixed gas, H₂/N₂ mixed gas, or H₂/He mixed gas. The volume ratio of the mixed gas may be about 1/99 to about 99/1, or may be, for example, about 3/97 to about 97/3 or about 5/95 to about 95/5. Within the above volume ratio range, reduced particles (exsolved B′ metal particles) having a uniform and even distribution can be smoothly formed.

The heat treatment temperature under reducing conditions may be about 600° C. to about 1000° C., for example, about 700° C. to about 900° C. Within the above heat treatment temperature range, reduced particles (exsolved B′ metal particles) can be uniformly formed, and the crystal structure of the perovskite oxide host material can be maintained.

The heat treatment can be performed for about 1 hour to about 24 hours, about 1 hour to about 12 hours, or about 2 hours to about 10 hours. Within the above heat treatment time range, reduced particles (exsolved B′ metal particles) can be uniformly formed, and the crystal structure of the perovskite oxide host material can be maintained.

That is, in the gas decomposition catalyst according to an embodiment, the crystal structure of the perovskite oxide host material can be maintained before and after the reduction heat treatment.

The gas decomposition catalyst prepared by the method of preparing a gas decomposition catalyst according to an embodiment may be a catalyst of decomposing nitrous oxide (N₂O) gas.

### Method of Decomposing Nitrous Oxide Gas

A method of decomposing a nitrous oxide (N₂O) gas according to another embodiment includes contacting a gas including nitrous oxide with a gas decomposition catalyst to decompose a nitrous oxide (N₂O) gas, wherein the gas decomposition catalyst includes: a perovskite oxide host material containing a B′ element and represented by Formula 1 below; and
at least one B′ element protruding particle derived from some or all of the B′ element,
wherein the B′ element protruding particle has a shape in which a portion of the particle is fixed inside the perovskite oxide host material and the other portion of the particle protrudes from the surface of the perovskite oxide host material:

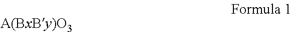

wherein, in Formula I, A may be lanthanum (La), strontium (Sr), or a combination thereof,
B may be a transition metal having an oxidation number of +3, +4, or +5,
B′ may be an element having a Gibbs free energy

$$( Δ {G}_{red}^{900 C} )$$

of 0 or less for a reduction reaction at 900° C. according to Reaction Formula 1, and

$$0 < x < 1 , 0 < y < 1 , and x + y = 1 :$$

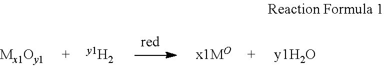

wherein, in Reaction Formula 1, x1 and y1 are each positive rational numbers, “red” refers to the reduction reaction, and M is a metal.

The gas including nitrous oxide mainly includes a semiconductor gas including nitrous oxide, but also includes gases emitted during a display manufacturing process and a flue gas as a result of combustion in a combustion engine. The contacting method is not limited, but for example, a chamber process may be used to cause a gas flow from a gas inlet unit to contact and react with a gas decomposition catalyst.

The method of decomposing a nitrous oxide (N₂O) gas according to an embodiment may operate in a low-temperature operating environment, for example, at a temperature of about 600° C. to about 800° C., thereby consuming less energy, being thermally and chemically stable, and exhibiting improved nitrous oxide decomposition performance.

B may include at least one of aluminum (Al), titanium (Ti), iron (Fe), chromium (Cr), niobium (Nb), molybdenum (Mo), barium (Ba), and tantalum (Ta), and B′ includes at least one element selected from cobalt (Co), nickel (Ni), iron (Fe), copper (Cu), manganese (Mn), rhodium (Rh), palladium (Pd), iridium (Ir), platinum (Pt), or gold (Au).

The B′ element protruding particle is a reduced particle formed by exsolution from the inside of the perovskite oxide host material onto the surface of the perovskite oxide host material.

When the gas decomposition catalyst is subjected to reduction heat treatment at a temperature of 900° C. to form B′ element protruding particles protruding from or on the surface of the perovskite oxide host material, a conversion rate of nitrous oxide (N₂O) of the gas decomposition catalyst according to Equation 1 below at an operating temperature of 800° C. is 80% or more, about 80% to about 96%, or about 82% to about 96%.

$$Nitrous oxide ( {N}_{2} O ) conversion rate = [ \text{} ( 1 - content ( mol / s ) of N 2 O gas discharged to outside of reactor at each temperature ) / content ( mol / s ) of N 2 O gas introduced into gas mixer at each temperature ] \times 100. \qquad Equation 1$$

### Scrubber System

A scrubber system for decomposing a nitrous oxide (N₂O) gas according to another embodiment includes a gas inlet unit through which a process gas including nitrous oxide is introduced; a scrubber including the gas decomposition catalyst for decomposing a nitrous oxide (N₂O) from the process gas including nitrous oxide introduced from the gas inlet unit; and a gas outlet unit for discharging the process gas including nitrous oxide from which the nitrous oxide (N₂O) gas is removed by the scrubber, wherein the gas decomposition catalyst includes: a perovskite oxide host material containing a B′ element and represented by Formula 1 below; and at least one B′ element protruding particle derived from some or all of the B′ element, wherein the B′ element protruding particle has a shape in which a portion of the particle is fixed inside the perovskite oxide host material and the other portion of the particle protrudes from the surface of the perovskite oxide host material:

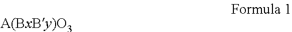

wherein, in Formula 1, A may be lanthanum (La), strontium (Sr), or a combination thereof,
B may be a transition metal having an oxidation number of +3, +4, or +5,
B′ may be an element having a Gibbs free energy

$$Δ {G}_{red}^{900 C}$$

of 0 or less for a reduction reaction at 900° C. according to Reaction Formula 1, and

$$0 < x < 1 , 0 < y < 1 , and x + y = 1 :$$

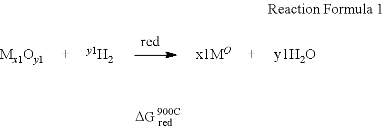

wherein, in Reaction Formula 1, x1 and y1 are each positive rational numbers, “red” refers to the reduction reaction, and M is a metal. For example, M may be a transition metal having an oxidation number of +3, +4, or +5.

“Process gas” as used herein is a gas from any source where it is desired to remove nitrous oxide, including a emission gas, a cleaning gas, a gas used in the manufacture of semiconductors, or the like. The process gas may be nitrous oxide or may include one or more other gases, specifically one or more other inert gases inert under conditions used to operate the scrubber system. The scrubber system for decomposing a nitrous oxide (N₂O) gas according to an embodiment may be used for treating an automobile exhaust gas, treating a semiconductor process gas, or treating a display process gas such as LCD. The scrubber system provides a system that decomposes a nitrous oxide (N₂O) gas with high efficiency at high temperatures under operating conditions, thereby preventing untreated nitrous oxide (N₂O) gas from being exhausted. Here, high temperature refers to a temperature of, for example, 600° C. or higher or 800° C. or higher.

The scrubber for decomposing a nitrous oxide (N₂O) gas according to another embodiment includes at least one reactor including a combustion chamber in which a process gas including nitrous oxide is introduced from the gas inlet unit and heated, a catalyst chamber in which the process gas including nitrous oxide heated from the combustion chamber is heated and introduced to react with the gas decomposition catalyst, e.g., a first gas decomposition catalyst, to decompose the nitrous oxide (N₂O) gas, and a heat storage chamber in which the process gas including nitrous oxide reacted with the gas decomposition catalyst is introduced from the catalyst chamber. The scrubber may further include additional chambers (e.g., a second catalyst chamber including a second gas decomposition catalyst for additional decomposition of nitrous oxide (N₂O) gas scrubbing after decomposition by the first catalyst.

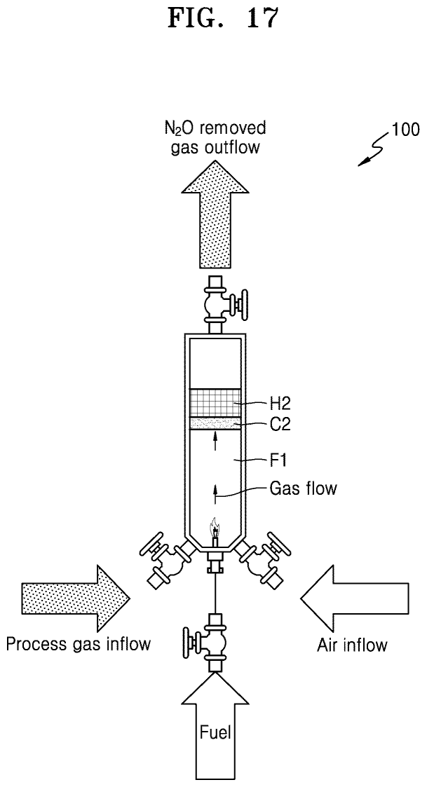

FIG. 17 is a schematic view of a scrubber system for decomposing a nitrous oxide (N₂O) gas according to an embodiment.

Referring to FIG. 17, a scrubber system for decomposing a nitrous oxide (N₂O) gas according to an embodiment includes a gas inlet unit through which a process gas including nitrous oxide is introduced; a scrubber including a reactor including a gas decomposition catalyst for decomposing a nitrous oxide (N₂O) from the process gas including nitrous oxide introduced from the gas inlet unit; and a gas outlet unit for discharging the gas including nitrous oxide from which the nitrous oxide (N₂O) gas is removed by the scrubber.

The scrubber system for decomposing nitrous oxide (N₂O) gas according to an embodiment may be designed as follows.

A process gas including nitrous oxide is introduced through a valve from a gas inlet unit. Examples of the process gas including nitrous oxide include silane (SiH₄) gas; hydrogen fluoride (HF) gas; fluorinated hydrocarbon gases such as CHF₃ and CH₂F₂; fluorinated carbon gases such as C₂F₄, C₂F₆, C₃F₆, C₃F₈, C₄F₈, and C₄F₁₀; fluorinated sulfur gases such as SF₄ and SF₆; fluorinated nitrogen gas such as NF₃; other gases capable of forming gaseous products such as HF; and nitrous oxide (N₂O) gas. The process gas including nitrous oxide is introduced into a scrubber including a gas decomposition catalyst for decomposing a nitrous oxide (N₂O) gas through a chemically coated valve. A valve through which air is introduced from an air inlet unit is provided at the other side of the scrubber. The amount of gas introduced into the scrubber is controlled by the valve through which air is introduced.

A heating device, e.g., a burner is placed between the gas inlet unit and the air inlet unit under the scrubber. A valve is provided directly on a fuel pipe to control the combustion amount of the burner. The input of heat may be controlled through a valve based on actual temperature in a combustion chamber F1. Additionally, a valve (not shown) connected to a combustion air fan may be installed next to a combustion control valve of the burner to prevent excessive combustion air from being introduced. The introduced gas including nitrous oxide and air are heated in the combustion chamber F1. The combustion chamber may be maintained at a temperature of, for example, about 800° C. to about 850° C.

The process gas including nitrous oxide heated from the combustion chamber F1 is introduced into a catalyst chamber C2 in which a nitrous oxide (N₂O) gas is decomposed, and reacts with the gas decomposition catalyst. The gas decomposition catalyst may be used in bulk form, i.e., as synthesized, having, for example, a shape of a sphere, an oval, a ring, or a cylinder itself, or may have a molded form. The catalytic shaping method is not limited, but for example, extrusion molding, tableting molding, and electromechanical assembly may be used. For example, the gas decomposition catalyst may be formed into a honeycomb or plate shape. Alternatively, the gas decomposition catalyst may be disposed in the catalyst chamber C2 in a layered (bed) form. For example, the layer in which the gas decomposition catalyst is disposed in the catalyst chamber C2 may be disposed in the form of a packed bed (or fixed bed) or a fluidized bed. The process gas including nitrous oxide introduced into the catalyst chamber C2 may be heated to a temperature at which the catalyst can react, for example, about 800° C.

A heat storage chamber H2 into which the process gas including nitrous oxide reacted with the gas decomposition catalyst is introduced from the catalyst chamber C2 is provided over the catalyst chamber C2. The heat storage chamber H2 may use a heat sink made of a ceramic material such as alumina. Heat sinks may be used in numbers greater than 100% of the amount of heat required to increase heat recovery efficiency. In addition, a monolithic type heat sink may be used to minimize pressure loss and power consumption. The process gas including nitrous oxide introduced into the heat storage chamber H2 loses heat as it passes through the heat sink and passes through a valve to remove nitrous oxide (N₂O) gas, and is then discharged.

Optionally, the scrubber system may additionally be provided with a gas condenser (not shown) over the scrubber to remove untreated nitrous oxide (N₂O) gas before the gas including nitrous oxide from which the nitrous oxide (N₂O) gas is removed is discharged. The gas condenser may condense the vapor gas discharged from the scrubber into process condensate. The process condensate may also be used as cooling liquid to control the temperature in the scrubber by passing through a transfer pipe (not shown) between the gas condenser (not shown) and the scrubber.

Alternatively, in the scrubber system according to an embodiment, when a combustion chamber is provided over a reactor of a scrubber, the positions of the above-described catalyst chamber and heat storage chamber are reversed.

Optionally, the scrubber system according to an embodiment may be provided with a preliminary heat storage chamber to preliminarily heat the process gas including nitrous oxide prior to installation of the reactor such that process gas including nitrous oxide having a substantial catalyst decomposition temperature is introduced into the catalyst chamber C2. For example, a preliminary heat storage chamber may be additionally provided between the catalyst chamber C2 and the combustion chamber F1. The preliminary heat storage chamber may use a heat sink made of the same ceramic material as the heat storage chamber H2. The degree of temperature increase of the introduced process gas including nitrous oxide may be controlled depending on the amount and initial temperature of the heat sink used in the preliminary heat storage chamber.

The scrubber system according to an embodiment may have a structure in which two or more of the reactors are arranged in parallel.

For example, the scrubber system according to an embodiment may have a structure in which a first reactor provided with a first heat storage chamber and a first catalyst chamber and a second reactor provided with a second heat storage chamber and a second catalyst chamber are arranged in parallel and a combustion chamber having a burner thereover is disposed.

The scrubber system for decomposing a nitrous oxide (N₂O) gas according to an embodiment may have a structure in which, in addition to the first reactor and the second reactor arranged in parallel as described above, a third reactor, a fourth reactor, or the like is additionally arranged in parallel.

This scrubber system for decomposing a nitrous oxide (N₂O) gas can improve an efficiency of treating a nitrous oxide (N₂O) gas while minimizing fuel consumption.

In the scrubber system including the gas decomposition catalyst, the operating temperature of the scrubber system is about 300° C. to about 900° C., about 300° C. to about 800° C., or about 400° C. to about 800° C. At these operating temperatures, a decomposition efficiency of a nitrous oxide is greatly improved.

The weight hourly space velocity (WHSV) is about 1,000 milliliter grams of substance per gram of catalytic unit per hour (mLg (cat)⁻¹h⁻¹) to about 500,000 mLg (cat)⁻¹h⁻¹, about 10,000 mLg (cat)⁻¹h⁻¹ to about 100,000 mLg (cat)⁻¹h⁻¹, about 10,000 mLg (cat)⁻¹h⁻¹ to about 80,000 mLg (cat)⁻¹h⁻¹, or about 20,000 mLg (cat)⁻¹h⁻¹ to about 70,000 mLg (cat)⁻¹h⁻¹. When the weight hourly space velocity is within the above range, a decomposition efficiency of a nitrous oxide is greatly improved.

Herein, the weight hourly space velocity (WHSV) is expressed as a ratio of the flow rate of nitrous oxide to the weight of the gas decomposition catalyst.

According to another aspect, there is provided a method of decomposing a nitrous oxide (N₂O) gas by contacting a nitrous oxide-containing gas, i.e., a process gas including nitrous oxide with a gas decomposition catalyst using a scrubber system.

The scrubber system includes a gas inlet unit through which a process gas including nitrous oxide is introduced, a scrubber including a gas decomposition catalyst for decomposing a nitrous oxide (N₂O) from the process gas including nitrous oxide introduced from the gas inlet unit, and a gas outlet unit for discharging the process gas from which the nitrous oxide (N₂O) gas is removed by the scrubber.

The gas decomposition catalyst includes a perovskite oxide host material containing a B′ element and represented by Formula 1 below; and at least one B′ element protruding particle derived from some or all of the B′ element, wherein the B′ element protruding particle has a shape in which a portion of the particle is fixed inside the perovskite oxide host material and the other portion of the particle protrudes from the surface of the perovskite oxide host material:

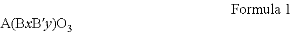

wherein, in Formula I, A may be one of lanthanum (La), strontium (Sr), or a combination thereof,
B may be a transition metal having an oxidation number of +3, +4, or +5,
B′ may be an element having a Gibbs free energy of 0 or less for a reduction reaction at 900° C. according to Reaction Formula 1, and

$$0 < x < 1 , 0 < y < 1 , and x + y = 1 :$$

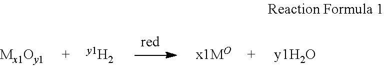

wherein, in Reaction Formula 1, x1 and y1 are each positive rational numbers, “red” refers to the reduction reaction, and M is a metal.

According to the method of decomposing nitrous oxide of an embodiment, nitrous oxide may be directly decomposed into N₂ and O₂. When using this decomposition method, high gas decomposition efficiency can be achieved stably even at high temperatures. In addition, improved gas decomposition efficiency while maintaining high energy efficiency and simplicity can be achieved.

Hereinafter, the disclosure will be described in more detail using the following examples and comparative examples, but the technical scope of the disclosure is not limited to the following examples.

In Example, The Gibbs free energies for the reduction of Fe (Fe₂O₃) was −15.38 kJ mol₋₁, the Gibbs free energies for the reduction of Co (CoO) was −33.48 kJ mol⁻¹, and the Gibbs free energies for the reduction of Ni (NiO) was −51.58 kJ mol⁻¹ (ACS Nano 2021, 15, 81).

### Example 1: La(Al_{0.9}Co_{0.1})O₃ (LAC) Gas Decomposition Catalyst (Reduction Heat Treatment Temperature: 700° C.)

La₂O₃, Al₂O₃, and Co₃O₄ were introduced into a reactor at a stoichiometric ratio of 1:0.9:0.1 to obtain La(Al_{0.9}Co_{0.1}) O₃, and mixed to obtain a precursor mixture. Ethanol was added to the precursor mixture, and wet milling was performed using a ball mill for 12 hours to obtain precursor powder. Here, the content of ethanol was 2,000 parts by weight based on 100 parts by weight of the total content of La₂O₃, Al₂O₃, and Co₃O₄.

The precursor powder was dried at 150° C. to remove ethanol, and then pelletized under pressure at room temperature (25° C.) for 1 minute at a pressure of 0.06 gigapascals (GPa) to obtain pellets.

The pellets were heat-treated at 1400° C. for 8 hours in an oxygen atmosphere to obtain a La(Al_{0.9}Co_{0.1}) O₃ perovskite oxide solid solution. This solid solution was pulverized with mortar to obtain La(Al_{0.9}Co_{0.1}) O₃ perovskite powder.

The La(Al_{0.9}Co_{0.1}) O₃ perovskite powder was heat-treated under reducing conditions at 700° C. for 10 hours in a hydrogen (H₂)/argon (Ar) (5/95, (v/v)) atmosphere to prepare a gas decomposition catalyst. This gas decomposition catalyst has a structure in which spherical cobalt (Co) element protruding particles are formed.

### Example 2: La(Al_{0.9}Co_{0.1}) O₃ Gas Decomposition Catalyst (Reduction Heat Treatment Temperature: 800° C.)

A La(Al_{0.9}Co_{0.1})O₃ gas decomposition catalyst was prepared in the same manner as in Example 1, except that the temperature was changed to 800° C. during heat treatment under reducing conditions.

### Example 3: La(Al_{0.9}Co_{0.1}) O₃ Gas Decomposition Catalyst (Reduction Heat Treatment Temperature: 900° C.)

A La(Al_{0.9}Co_{0.1}) O₃ gas decomposition catalyst was prepared in the same manner as in Example 1, except that the temperature was changed to 900° C. during heat treatment under reducing conditions.

### Comparative Example 1: LaAlO₃ Gas Decomposition Catalyst (Reduction Heat Treatment Temperature: 700° C.)

A LaAlO₃ gas decomposition catalyst was prepared in the same manner as in Example 1, except that Co₃O₄ was not added when preparing the precursor mixture.

### Example 4: LaAl_{0.9}Co_{0.075}Ni_{0.025}O₃ (LACN25) Gas Decomposition Catalyst (Reduction Heat Treatment Temperature: 700° C.)

A gas decomposition catalyst was prepared in the same manner as in Example 1, except that NiO was further added in addition to La₂O₃, Al₂O₃, and Co₃O₄ in the preparation of the precursor mixture, and La₂O₃, Al₂O₃, Co₃O₄, and NiO were mixed in stoichiometric amounts so as to obtain LaAl_{0.9}Co_{0.075}Ni_{0.025}O₃ (LACN25) to obtain the precursor mixture.

### Example 4-1: LaAl_{0.9}Co_{0.075}Ni_{0.025}O₃ (LACN25) Gas Decomposition Catalyst (Reduction Heat Treatment Temperature: 800° C.)

A gas decomposition catalyst was prepared in the same manner as in Example 4, except that the temperature was changed to 800° C. during heat treatment under reducing conditions.

### Example 4-2: LaAl_{0.9}Co_{0.075}Ni_{0.025}O₃ (LACN25) Gas Decomposition Catalyst (Reduction Heat Treatment Temperature: 900° C.)

A gas decomposition catalyst was prepared in the same manner as in Example 4, except that the temperature was changed to 900° C. during heat treatment under reducing conditions.

### Example 5: LaAl_{0.9}Co_{0.05}Ni_{0.05}O₃ (LACN50) Gas Decomposition Catalyst (Reduction Heat Treatment Temperature: 700° C.)

A gas decomposition catalyst was prepared in the same manner as in Example 1, except that NiO was further added in addition to La₂O₃, Al₂O₃, and Co₃O₄ in the preparation of the precursor mixture, and La₂O₃, Al₂O₃, Co₃O₄, and NiO were mixed in stoichiometric amounts so as to obtain LaAl_{0.9}Co_{0.05}Ni_{0.05}O₃ (LACN50) to obtain the precursor mixture.

### Example 5-1: LaAl_{0.9}Co_{0.05}Ni_{0.05}O₃ (LACN50) Gas Decomposition Catalyst (Reduction Heat Treatment Temperature: 800° C.)

A gas decomposition catalyst was prepared in the same manner as in Example 5, except that the temperature was changed to 800° C. during heat treatment under reducing conditions.

### Example 5-2: LaAl_{0.9}Co_{0.05}Ni_{0.05}O₃ (LACN50) Gas Decomposition Catalyst (Reduction Heat Treatment Temperature: 900° C.)

A gas decomposition catalyst was prepared in the same manner as in Example 5, except that the temperature was changed to 900° C. during heat treatment under reducing conditions.

### Example 6: LaAl_{0.9}Co_{0.025}Ni_{0.075}O₃ (LACN75) Gas Decomposition Catalyst (Reduction Heat Treatment Temperature: 700° C.)

A gas decomposition catalyst was prepared in the same manner as in Example 1, except that NiO was further added in addition to La₂O₃, Al₂O₃, and Co₃O₄ in the preparation of the precursor mixture, and La₂O₃, Al₂O₃, Co₃O₄, and NiO were mixed in stoichiometric amounts so as to obtain LaAl_{0.9}Co_{0.025}Ni_{0.075}O₃ (LACN75) to obtain the precursor mixture.

### Example 6-1: LaAl_{0.9}Co_{0.025}Ni_{0.075}O₃ (LACN75) Gas Decomposition Catalyst (Reduction Heat Treatment Temperature: 800° C.)

A gas decomposition catalyst was prepared in the same manner as in Example 6, except that the temperature was changed to 800° C. during heat treatment under reducing conditions.

### Example 6-2: LaAl_{0.9}Co_{0.025}Ni_{0.075}O₃ (LACN75) Gas Decomposition Catalyst (Reduction Heat Treatment Temperature: 900° C.)

A gas decomposition catalyst was prepared in the same manner as in Example 6, except that the temperature was changed to 900° C. during heat treatment under reducing conditions.

### Example 7: LaAl_{0.9}Ni_{0.1}O₃ (LACN100) Gas Decomposition Catalyst (Reduction Heat Treatment Temperature: 700° C.)

A gas decomposition catalyst was prepared in the same manner as in Example 1, except that La₂O₃, Al₂O₃ and NiO were used in the preparation of the precursor mixture, and La₂O₃, Al₂O₃ and NiO were mixed in stoichiometric amounts so as to obtain LACN100 to obtain the precursor mixture.

### Example 7-1: LaAl_{0.9}Ni_{0.1}O₃ (LACN100) Gas Decomposition Catalyst (Reduction Heat Treatment Temperature: 800° C.)

A gas decomposition catalyst was prepared in the same manner as in Example 7, except that the temperature was changed to 800° C. during heat treatment under reducing conditions.

### Example 7-2: LaAl_{0.9}Ni_{0.1}O₃ (LACN100) Gas Decomposition (Reduction Heat Treatment Temperature: 900° C.)

A gas decomposition catalyst was prepared in the same manner as in Example 7, except that the temperature was changed to 900° C. during heat treatment under reducing conditions.

### Example 8: LaAl_{0.9}Co_{0.075}Fe_{0.025}O₃ (LACF25) Gas Decomposition Catalyst (Reduction Heat Treatment Temperature: 700° C.)

A gas decomposition catalyst was prepared in the same manner as in Example 1, except that Fe₂O₃ was further added in addition to La₂O₃, Al₂O₃, and Co₃O₄ in the preparation of the precursor mixture, and La₂O₃, Al₂O₃, Co₃O₄, and Fe₂O₃ were mixed in stoichiometric amounts so as to obtain LaAl_{0.9}Co_{0.075}Fe_{0.025}O₃ (LACF25) to obtain the precursor mixture.

### Example 8-1: LaAl_{0.9}Co_{0.075}Fe_{0.025}O₃ (LACF25) Gas Decomposition Catalyst (Reduction Heat Treatment Temperature: 800° C.)

A gas decomposition catalyst was prepared in the same manner as in Example 8, except that the temperature was changed to 800° C. during heat treatment under reducing conditions.

### Example 8-2: LaAl_{0.9}Co_{0.075}Fe_{0.025}O₃ (LACF25) Gas Decomposition Catalyst (Reduction Heat Treatment Temperature: 900° C.)

A gas decomposition catalyst was prepared in the same manner as in Example 8, except that the temperature was changed to 900° C. during heat treatment under reducing conditions.

### Example 9: LaAl_{0.9}Co_{0.05}Fe_{0.05}O₃ (LACF50 Gas Decomposition Catalyst (Reduction Heat Treatment Temperature: 700° C.)

A gas decomposition catalyst was prepared in the same manner as in Example 1, except that Fe₂O₃ was further added in addition to La₂O₃, Al₂O₃, and Co₃O₄ in the preparation of the precursor mixture, and La₂O₃, Al₂O₃, Co₃O₄, and Fe₂O₃ were mixed in stoichiometric amounts so as to obtain LACF50 to obtain the precursor mixture.

### Example 10: LaAl_{0.9}Co_{0.025}Fe_{0.075}O₃ (LACF75) Gas Degradation Catalyst (Reduction Heat Treatment Temperature: 700° C.)

A gas decomposition catalyst was prepared in the same manner as in Example 1, except that Fe₂O₃ was further added in addition to La₂O₃, Al₂O₃, and Co₃O₄ in the preparation of the precursor mixture, and La₂O₃, Al₂O₃, Co₃O₄, and Fe₂O₃ were mixed in stoichiometric amounts so as to obtain LaAl_{0.9}Co_{0.025}Fe_{0.075}O₃ (LACF75) to obtain the precursor mixture.

### Example 11: LaAl_{0.9}Fe_{0.1}O₃ (LACF100) Gas Decomposition Catalyst (Reduction Heat Treatment Temperature: 700° C.)

A gas decomposition catalyst was prepared in the same manner as in Example 1, except that La₂O₃, Al₂O₃, and Fe₂O₃ were used in the preparation of the precursor mixture, and La₂O₃, Al₂O₃, and Fe₂O₃ were mixed in stoichiometric amounts so as to obtain LaAl_{0.9}Fe_{0.1}O₃ (LACF100) to obtain the precursor mixture.

### EVALUATION EXAMPLES

### Evaluation Example 1: X-Ray Diffraction (XRD) Analysis (I)

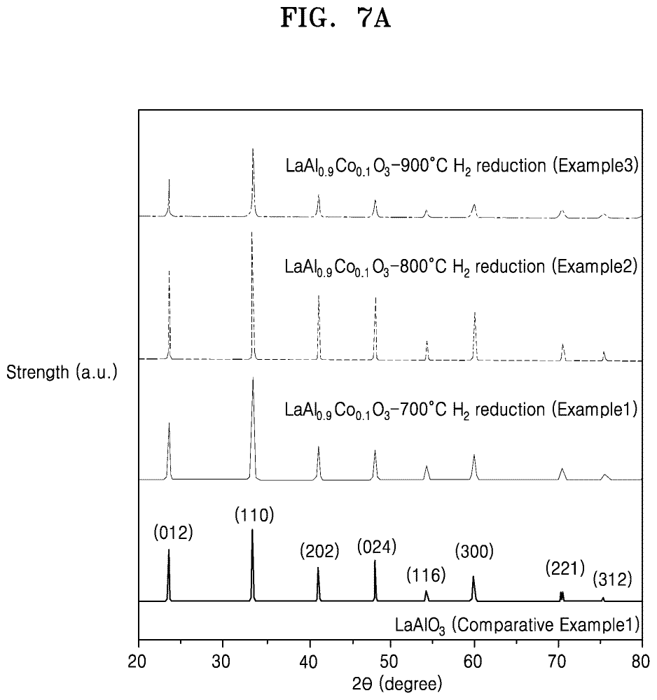

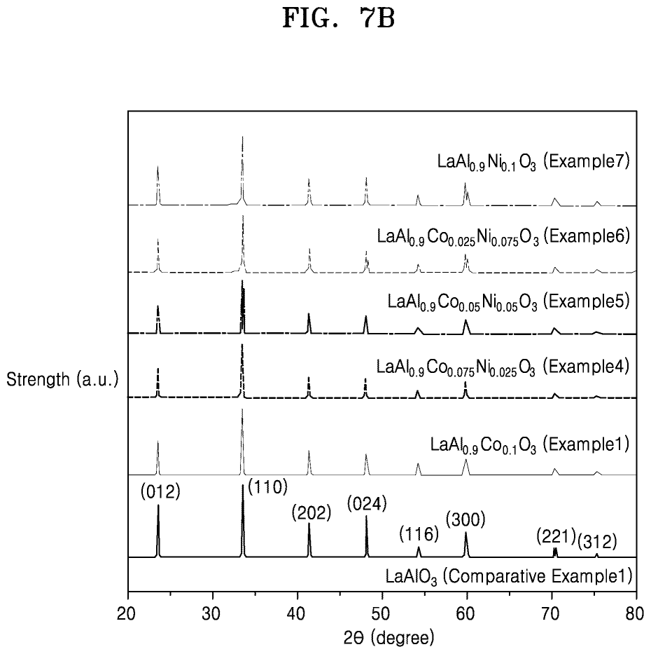

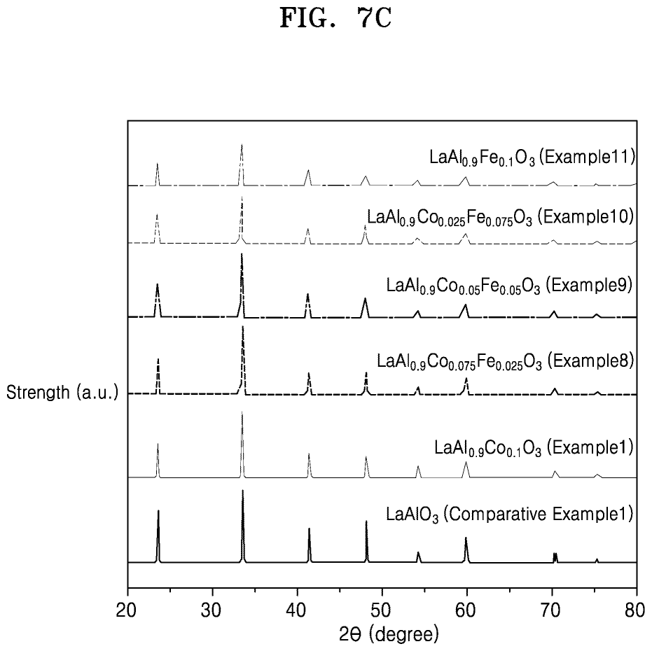

XRD analysis using CuKα rays was performed on the gas decomposition catalysts prepared in Examples 1 to 3 and Comparative Example 1. The results thereof are shown in FIG. 7A. XRD analysis was performed at 1 degree per minute (°/min) with a diffraction angle 20 ranging from 20° to 80°. The results thereof are shown in FIG. 7A.

Referring to FIG. 7A, the gas decomposition catalysts prepared in Examples 1 to 3 showed no change in the crystal structure of the host material (LaAlO₃) of Comparative Example 1 even after cobalt nanoparticles were exsolved. Evaluation Example 2: XRD Analysis (II)

XRD analysis using CuKα rays was performed to confirm the crystal structure of the gas decomposition catalysts prepared in Examples 1 and 4 to 7 and Comparative Example 1 after reduction. The results thereof are shown in FIG. 7B.

As shown in FIG. 7B, the gas decomposition catalysts showed no change in the crystal structure of the host material (LaAlO₃) of Comparative Example 1.

### Evaluation Example 3: XRD Analysis (III)

XRD spectrum experiments using CuKα rays was performed to confirm the crystal structure of the gas decomposition catalysts prepared in Examples 1 and 8 to 11 and Comparative Example 1 after reduction. The results thereof are shown in FIG. 7C.

Referring to FIG. 7C, it was confirmed that the gas decomposition catalysts of Examples 1 and 8 to 11 showed no change in the crystal structure of the host material (LaAlO₃) of Comparative Example 1.

### Evaluation Example 4: SEM Analysis (I)

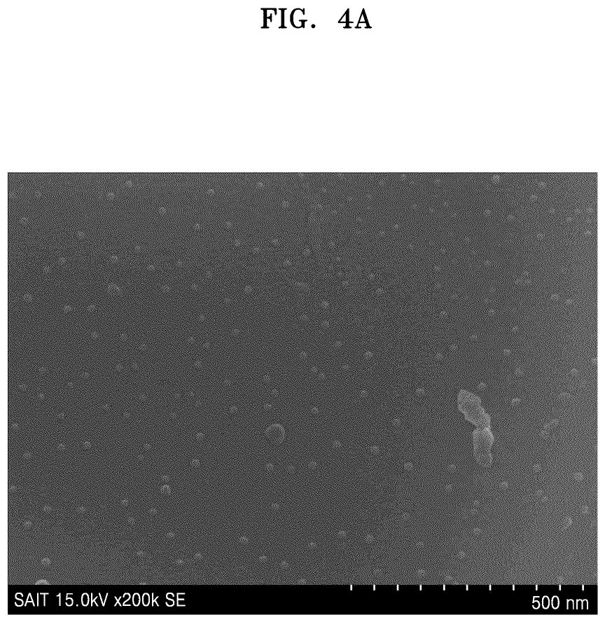

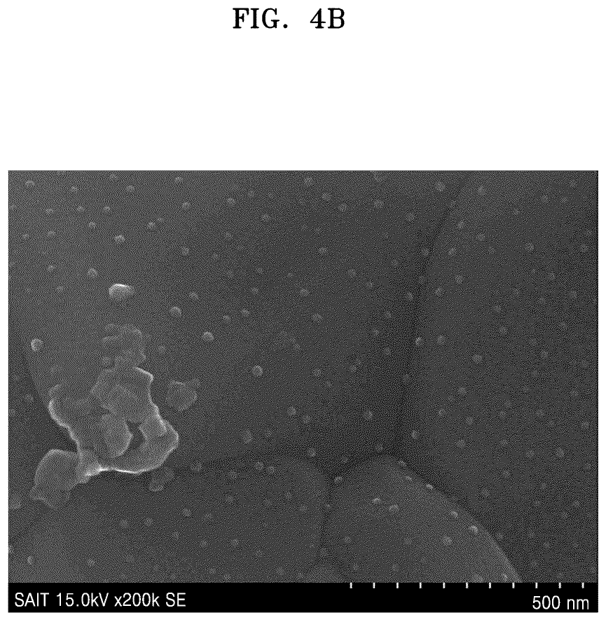

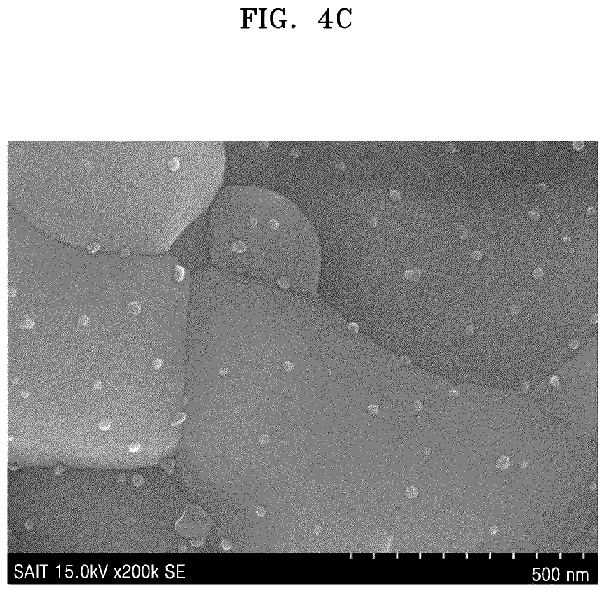

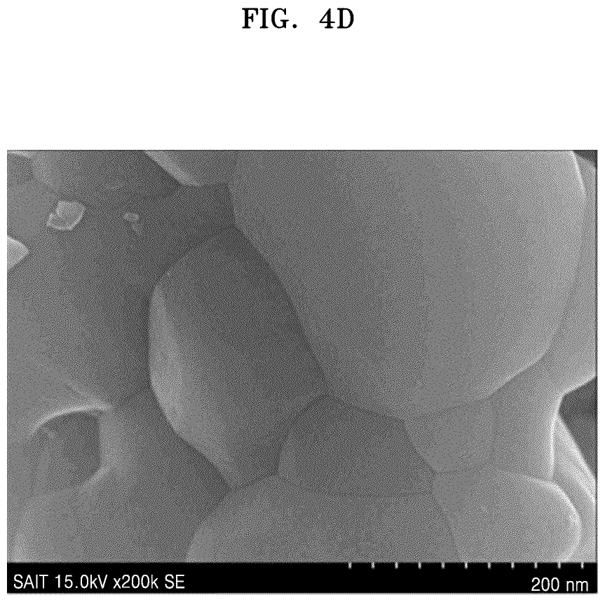

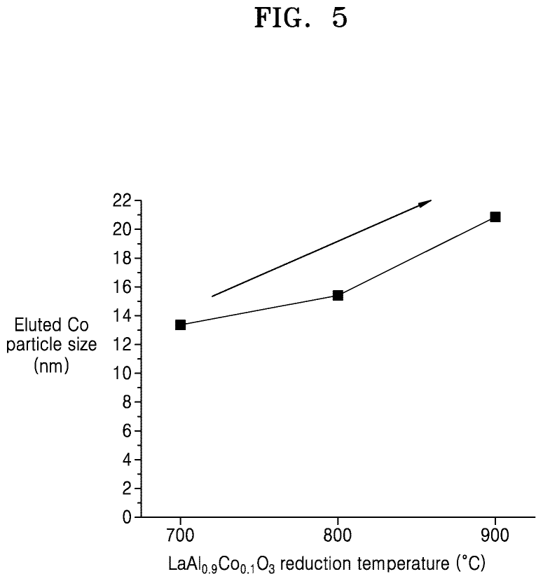

SEM analysis was performed to confirm the surface states of the gas decomposition catalysts prepared in Examples 1 to 3 and Comparative Example 1 after reduction, and the analysis results thereof are shown in FIGS. 4A to 4D, respectively. The scanning electron microscope (SEM) used for the SEM analysis was SU-9000 of Hitachi, Ltd. In addition, the change in the size of exsolved particles with respect to the heat treatment temperature under reducing conditions in the preparation of the gas decomposition catalyst is shown in FIG. 5.

As shown in FIGS. 4A to 4C, each of the gas decomposition catalysts of Examples 1 to 3 includes cobalt nanoparticles evenly distributed in a socket shape protruding from or on the surface of LaAlO₃ after the catalyst exsolution process. It was found that the exsolved nanoparticles have a spherical or nearly spherical shape, such as an ellipse, and were evenly dispersed on the host material, resulting in high performance and high durability even at high temperatures. As shown in FIG. 5, it was found that the size of the cobalt nanoparticles could be controlled depending on the temperature of the exsolution process. Further, it was found that as the temperature of the exsolution process increased, the size of the nanoparticles increased, and thus the size and distribution of the particles exsolved from the surface of the gas decomposition catalysts prepared in Examples 1 to 3 changed.

It could be confirmed that the average particle size of the cobalt nanoparticles exsolved from the surface of the gas decomposition catalysts prepared in Examples 1 to 3 was about 13 nm to about 20 nm, and the density thereof was about 50//μm² to about 1000//μm². The average particle size of the gas decomposition catalysts is 10 nm to 45 nm.

### Evaluation Example 5: SEM Analysis (II)

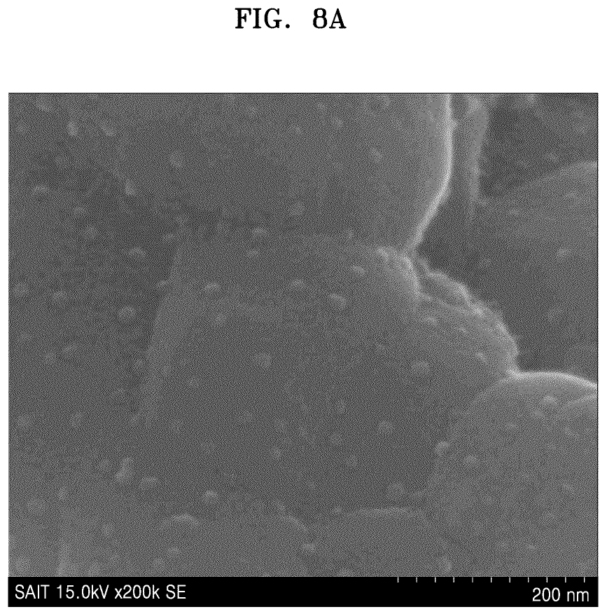

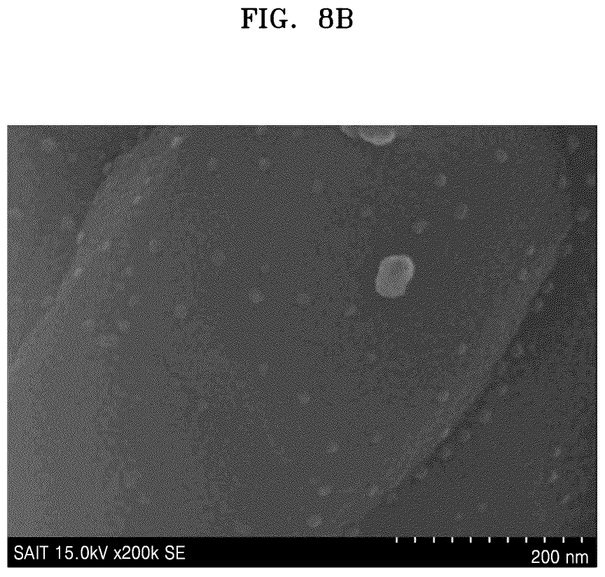

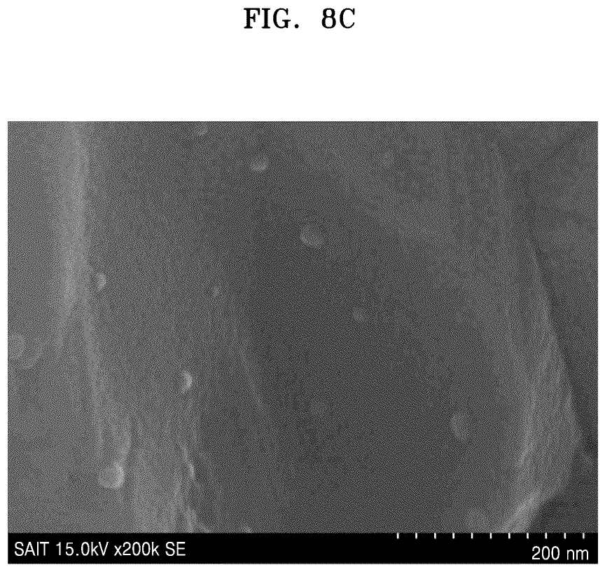

SEM analysis was performed to confirm the surface states of the gas decomposition catalysts prepared in Examples 5, 5-1, and 5-2 after reduction, and the analysis results thereof are shown in FIGS. 8A to 8C, respectively. The scanning electron microscope (SEM) used for the SEM analysis was SU-9000 of Hitachi, Ltd.

Referring to FIGS. 8A to 8C, a change in the size of exsolved particles according to reduction temperature could be found. As reduction temperature increased, the size of particles increased, and the density of particles decreased. As the density decreases, active sites increase, thereby improving a N₂O decomposition efficiency.

It could be confirmed that the diameter of the cobalt-nickel alloy nanoparticles exsolved from the surface of the gas decomposition catalysts prepared in Examples 5, 5-1, and 5-2 was about 10 nm to about 25 nm, and the density thereof was about 30//μm² to about 200//μm². The average particle size of the gas decomposition catalyst is 10 nm to 45 nm.

### Evaluation Example 6: SEM Analysis (III)

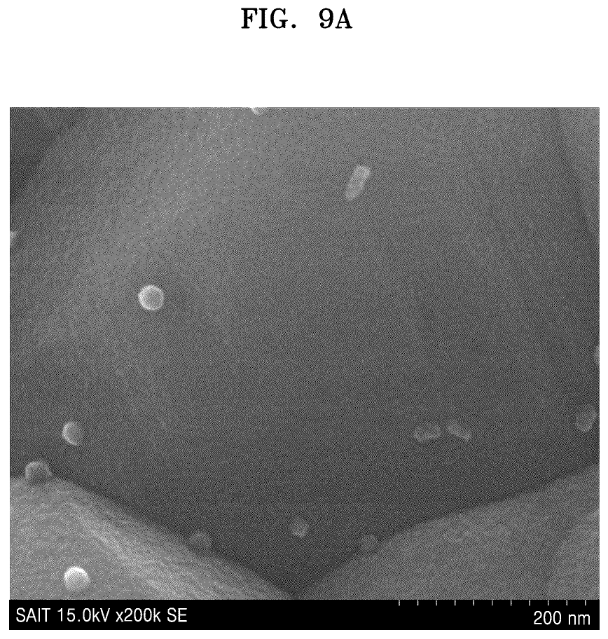

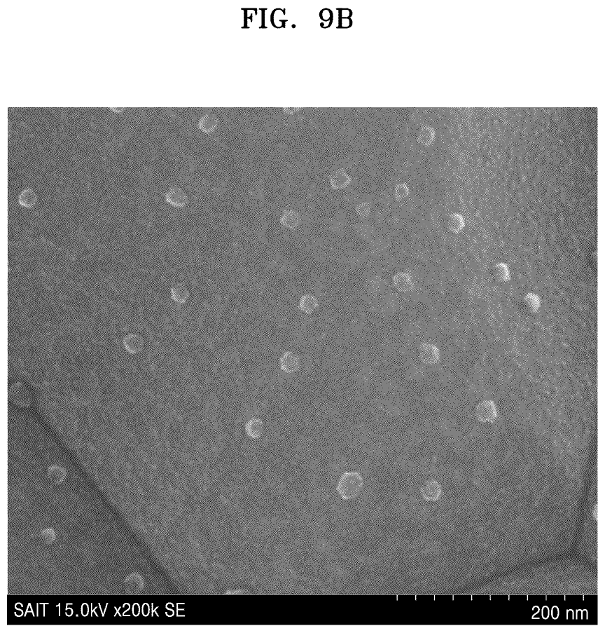

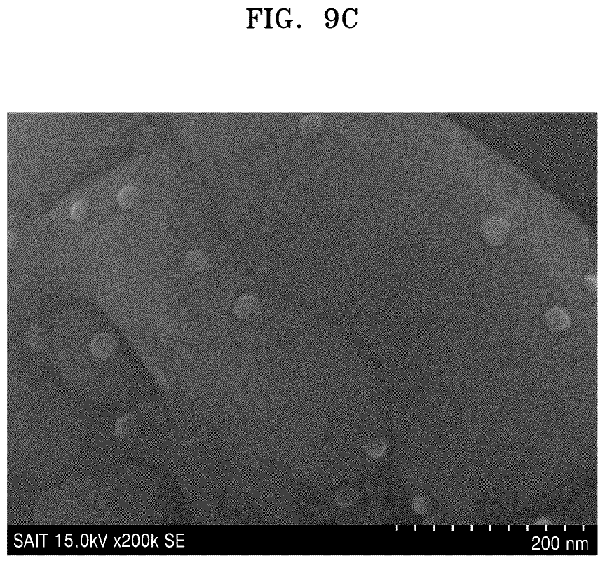

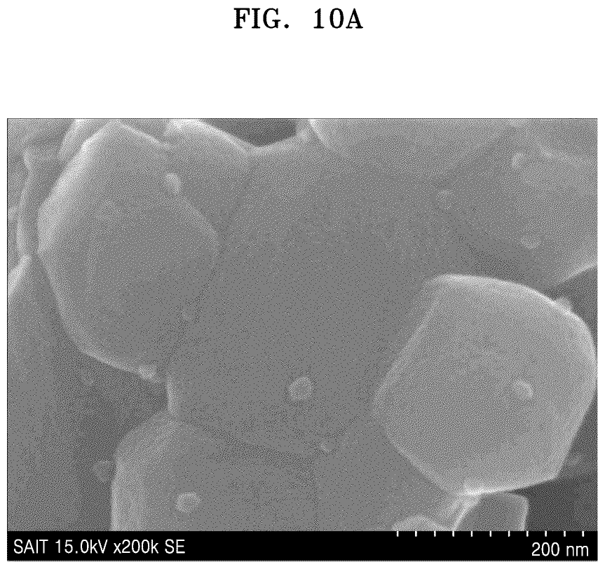

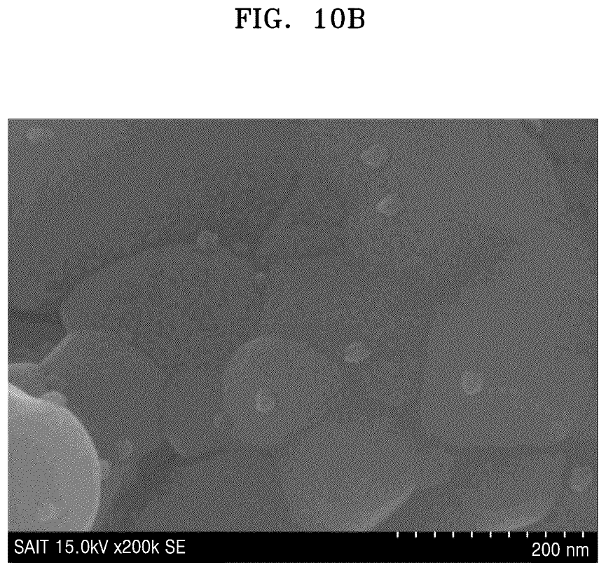

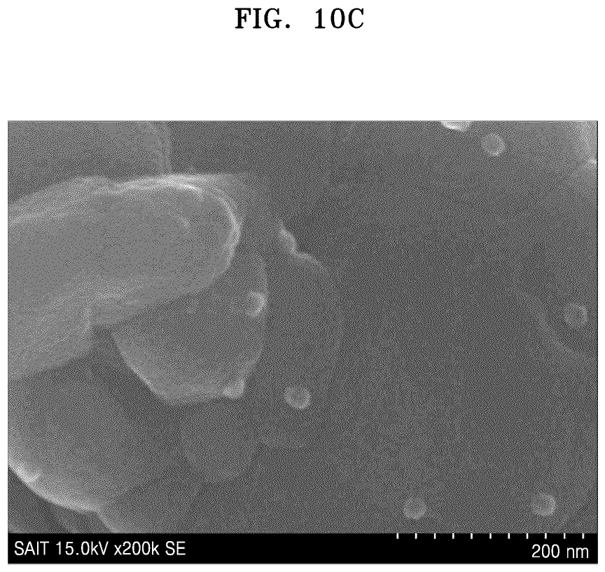

SEM analysis was performed to confirm the surface states of the gas decomposition catalysts prepared in Examples 8, 8-1, and 8-2 after reduction, and the analysis results thereof are shown in FIGS. 9A to 9C, respectively. The scanning electron microscope (SEM) used for the SEM analysis was SU-9000 of Hitachi, Ltd.

Referring to FIGS. 9A to 9C, a change in the size of exsolved particles according to reduction temperature could be found. As reduction temperature increased, the size of particles increased.

The particle size, density, and particle volume (V) per oxide coating layer area (A) (V_{Ex-solved particle}/A_{Host material (Perovskite)}) obtained in Evaluation Examples above are summarized in Table 1 below. In the oxide coating layer area, oxide refers to LaAlO₃ perovskite as a host material. Therefore, V_{Ex-solved particle}/A_{Host material (Perovskite)} refers to the volume of the elution catalyst per area of LaAlO₃ oxide (host material).

The particle size in Table 1 below represents an average particle diameter of the exsolved nanoparticles and was evaluated by SEM analysis.

TABLE 1

| | | Reduction heat | | | |
|---|---|---|---|---|---|
| | | treatment | Particle | Density | V/A |
| | | temperature | size | (number/ | (nm³/ |
| Class. | | (° C.) | (nm) | μm²) | nm²) |
| LAC | Example 1 | 700 | 16 | 100 | 0.3 |
| | Example 2 | 800 | 17 | 125 | 0.5 |
| | Example 3 | 900 | 21.5 | 40 | 0.27 |
| LACN25 | Example 4 | 700 | 14 | 275 | 0.28 |
| | Example 4-1 | 800 | 16.5 | 225 | 0.35 |
| | Example 4-2 | 900 | 18 | 50 | 0.21 |
| LACN50 | Example 5 | 700 | 13 | 400 | 0.53 |
| | Example 5-1 | 800 | 14 | 210 | 0.3 |
| | Example 5-2 | 900 | 21.5 | 39 | 0.25 |
| LCAN75 | Example 6 | 700 | 11 | 625 | 0.7 |
| | Example 6-1 | 800 | 12 | 325 | 0.32 |
| | Example 6-2 | 900 | 22 | 50 | 0.35 |
| LACN100 | Example 7 | 700 | 11.5 | 400 | 0.3 |
| | Example 7-1 | 800 | 12.2 | 175 | 0.15 |
| | Example 7-2 | 900 | 18 | 25 | 0.1 |

### Evaluation Example 7: N₂O Decomposition Performance Evaluation (I)

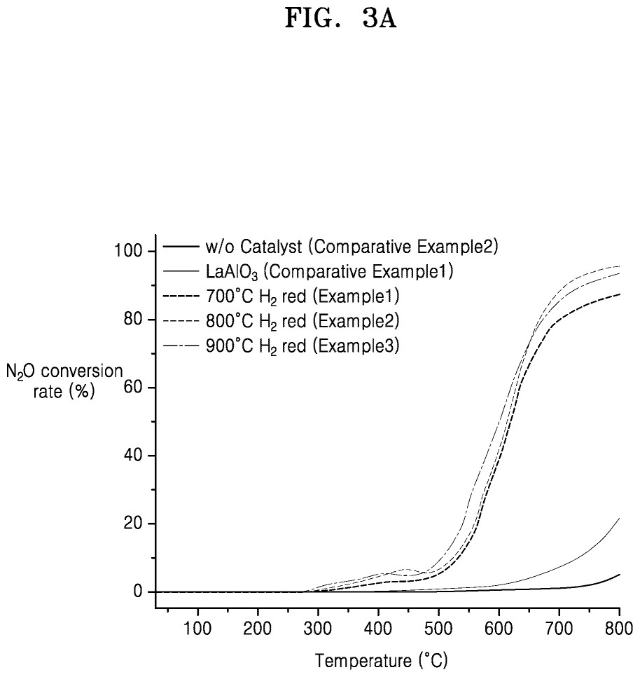

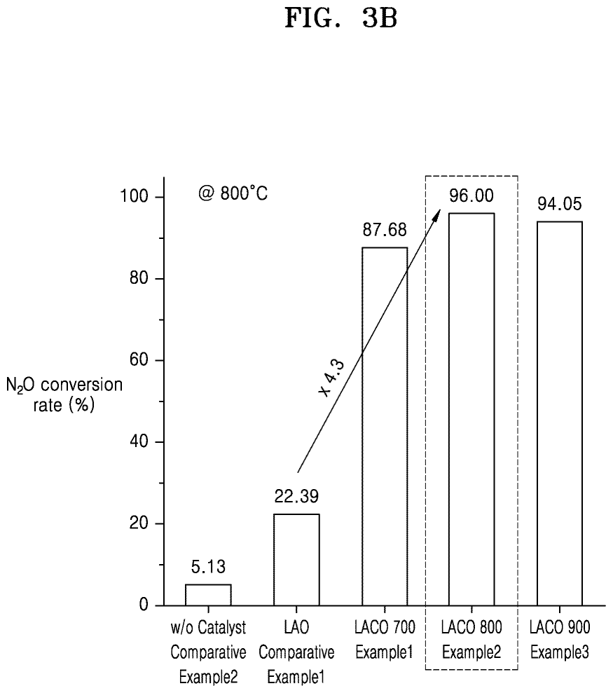

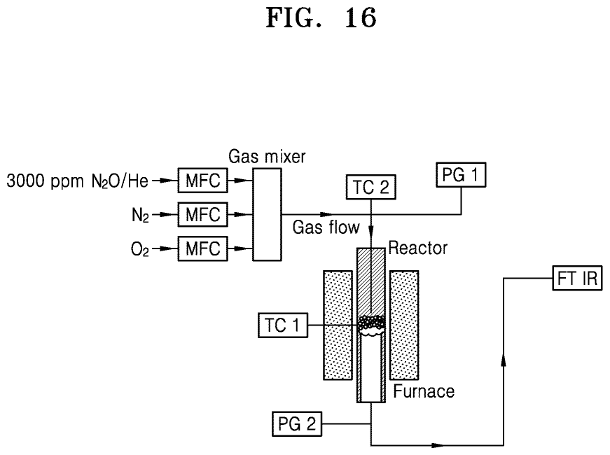

In order to evaluate the nitrous oxide (N₂O) gas decomposition performance with respect to the temperature of the gas decomposition catalysts prepared in Comparative Example 1 and Examples 1 to 3, a nitrous oxide (N₂O) gas decomposition system according to FIG. 16 to be described later was manufactured, and the nitrous oxide decomposition performance results are shown in FIG. 3A, and the nitrous oxide decomposition performance results at an operating temperature of 800° C. are shown in FIG. 3B. In addition, in order to compare with the gas decomposition system using the gas decomposition catalysts of Comparative Example 1 and Example 1-3, a gas decomposition system (Comparative Example 2) not using the gas decomposition catalyst was manufactured, and the results of the decomposition performance of nitrous oxide are shown in FIGS. 3A and 3B. Here, the heating rate is 4° C./min.

Specifically, the nitrous oxide (N₂O) gas decomposition system according to FIG. 16 is as follows.

The gas decomposition catalysts prepared in Examples 1 to 3 and Comparative Example 1 are arranged in a reactor in a layered (bed) form. Above the reactor, a gas mixer which is provided with three mass flow controllers MFCs and into which 3000 ppm N₂O/He balance 100 standard cubic centimeters per minute (sccm) gas, N₂ gas, and O₂ gas are introduced, a second thermocouple TC2 for measuring the temperature of a gas catalyst layer (bed), and a first pressure gauge PG1 for measuring pressure are connected with each other. Two furnaces for heating the reactor are arranged at both sides of the reactor, and a first thermocouple TC1 is connected to one side of the reactor. Below the reactor, a second pressure gauge PG2 for measuring pressure and a gas concentration measuring instrument FT-IR (MIDAC Corporation) for measuring the concentration of gas discharged from the inside of the reactor to the outside of the reactor are connected to each other. The weight hourly space velocity (WHSV) is about 60,000 mL g (cat)⁻¹ h⁻¹.

Using the nitrous oxide (N₂O) gas decomposition system according to FIG. 16, the N₂O decomposition performance of each gas decomposition catalyst was evaluated using Equation 1 below. The evaluation results are shown in FIGS. 3A and 3B. Comparative Example 2 in FIGS. 3A and 3B shows a case where a gas decomposition catalyst is not used.

$$Nitrous oxide ( {N}_{2} O ) conversion rate = [ \text{} ( 1 - content ( mol / s ) of N 2 O gas discharged to outside of reactor at each temperature ) / content ( mol / s ) of N 2 O gas introduced into gas mixer at each temperature ] \times 100. \qquad Equation 1$$

Referring to FIGS. 3A and 3B, it can be confirmed that all the gas decomposition catalysts prepared in Examples 1 to 3 have an increase in the conversion rate of nitrous oxide (N2O) as the temperature increases from 300° C. to 800° C., as compared with Comparative Examples 1 and 2. Here, the nitrous oxide (N₂O) conversion rate may be used interchangeably with the nitrous oxide (N₂O) decomposition efficiency.

From this, it can be confirmed that the N₂O decomposition performance of all of the perovskite oxide gas decomposition catalysts prepared in Examples 1 to 3 is greatly improved as the temperature increases. In particular, the N₂O decomposition performance of the gas decomposition catalyst prepared in Example 2 increased the most according to a temperature increase.

Referring to FIG. 3B, all of the gas decomposition catalysts prepared in Examples 1 to 3 at a temperature of 800° C. had a higher content of converted nitrous oxide (N₂O) and improved N₂O decomposition performance as compared with the gas decomposition catalyst prepared in Comparative Example 1 and the case of Comparative Example 2 that did not use a gas decomposition catalyst. In particular, the gas decomposition catalyst prepared in Example 2 had an excellent N₂O conversion rate of 96%, and an N₂O decomposition efficiency improved by about 4.3 times compared to the case where the gas decomposition catalyst of Comparative Example 1 was used (N₂O conversion efficiency: 22.39%). From this, the gas decomposition catalysts of Examples 1 to 3 showed that the N₂O decomposition efficiency was improved at a process temperature of 800° C.

### Evaluation Example 8: STEM-EDS Elemental Mapping Analysis (I)

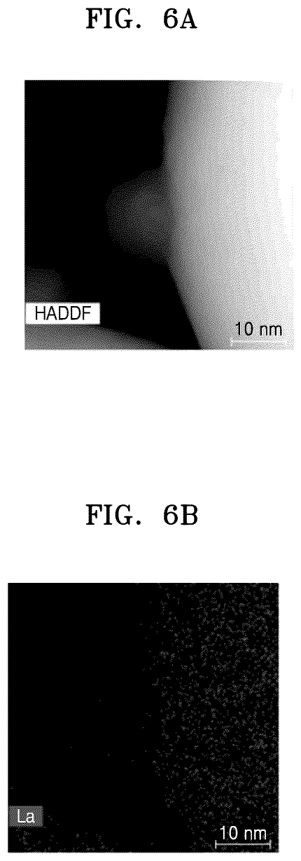

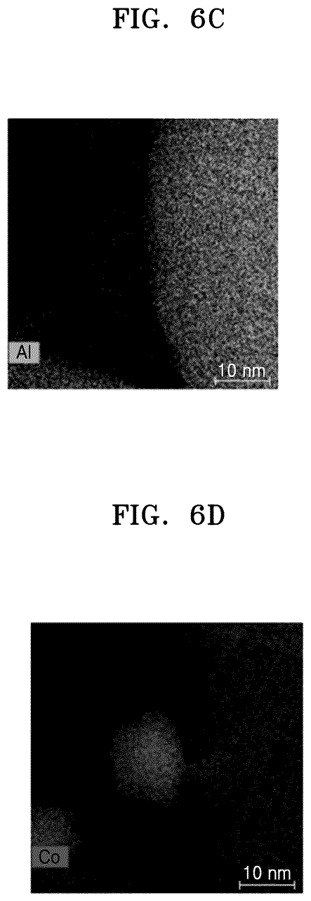

STEM-EDS analysis was performed on the gas decomposition catalyst prepared according to Example 2, and the analysis results thereof are shown in FIGS. 6A to 6D.

Referring to FIGS. 6A to 6D, it was confirmed that cobalt nanoparticles were exsolved in a socket shape onto LaAlO₃ after an exsolution process.

### Evaluation Example 9: HR-TEM and EDS Analysis

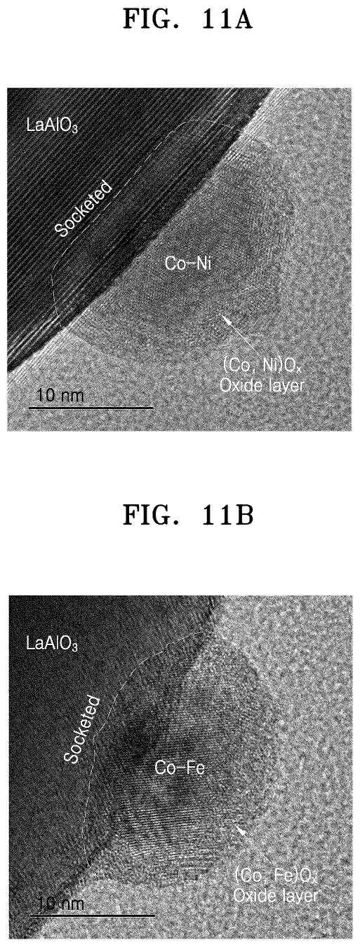

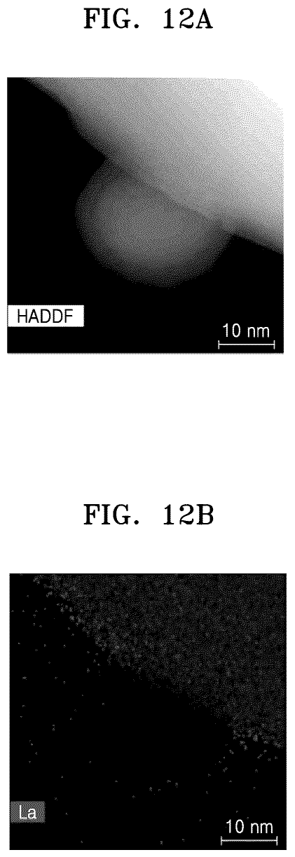

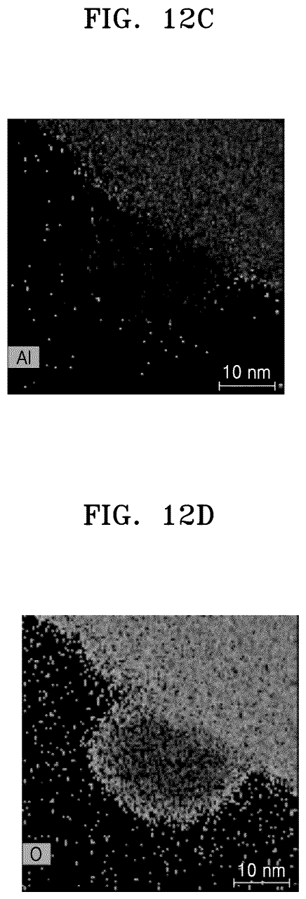

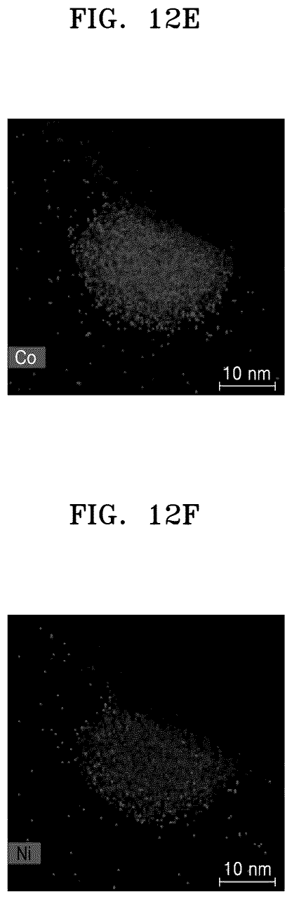

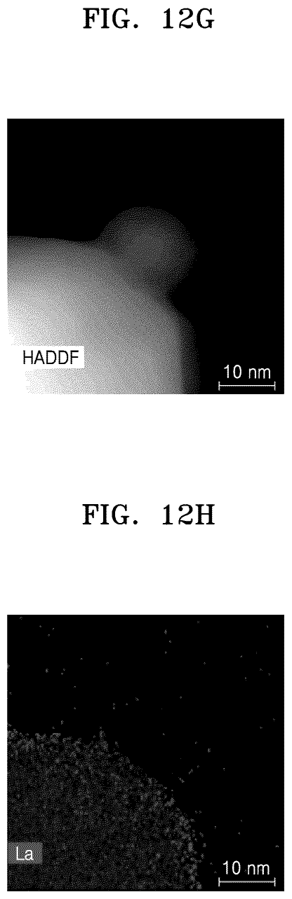

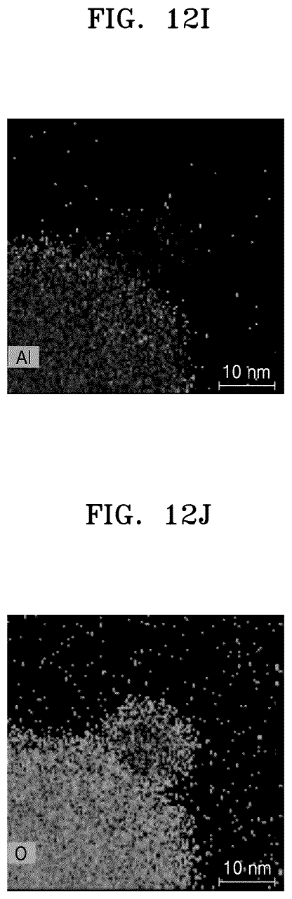

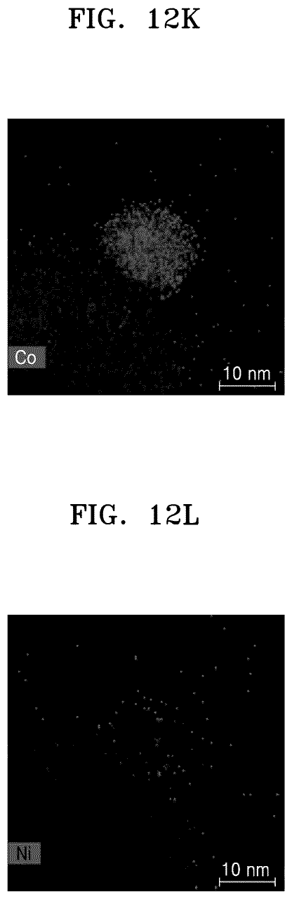

HR-TEM analysis was performed on the gas decomposition catalyst LACN25 prepared according to Example 4, and the analysis results thereof are shown in FIG. 11A. TEM-EDS analysis was performed on the gas decomposition catalyst LACN25 prepared according to Example 4, and the analysis results thereof are shown in FIGS. 12A to 12F. Further, TEM-EDS analysis was performed on the gas decomposition catalyst LAC prepared according to Example 1, and the analysis results thereof are shown in FIGS. 12G to 12L.

As shown in FIG. 11A, the Co—Ni alloy was well exsolved on the host (LaAlO₃). The exsolved particle has a socket particle shape, which is a structure embedded in the host (LaAlO₃), and a coating layer (shell) containing Co—Ni alloy (Co_{0.075}—Ni_{0.025} alloy) oxide is formed on the surface of the exsolved particle (core). The composition of the exsolved nanoparticles depends on the concentration of a dopant. As shown in FIG. 11A, the coating layer containing Co—Ni alloy oxide has a thickness of about 2 nm.

Referring to FIGS. 12A to 12F, it was found that the gas decomposition catalyst LACN25 prepared according to Example 4 existed in the form of nanoparticles in which a Co—Ni alloy was well exsolved, as compared with the gas decomposition catalyst LAC of Example 1 shown in FIGS. 12G to 12L. HR-TEM analysis was performed on the gas decomposition catalyst LACF50 prepared according to Example 9, and the analysis results thereof are shown in FIG. 11B.

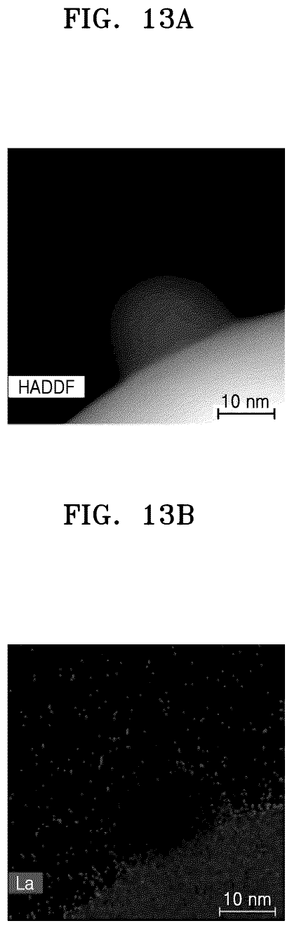

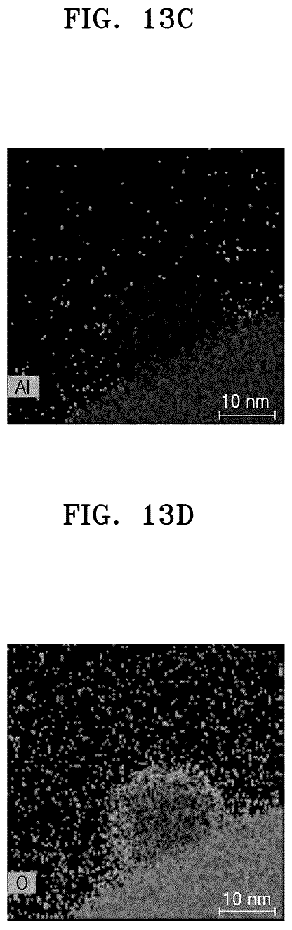

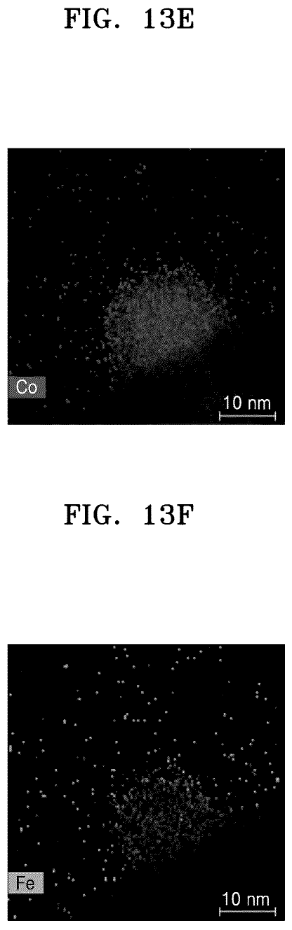

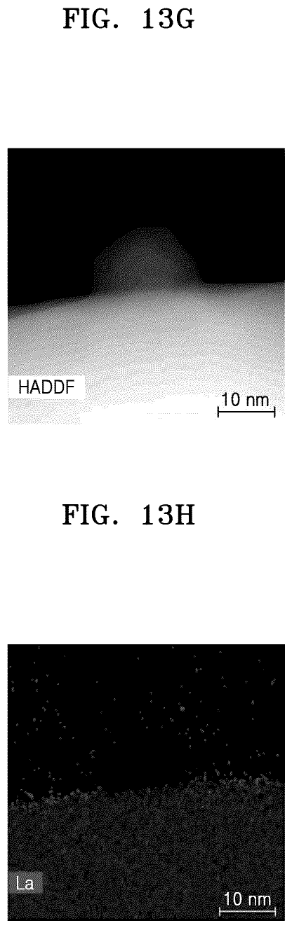

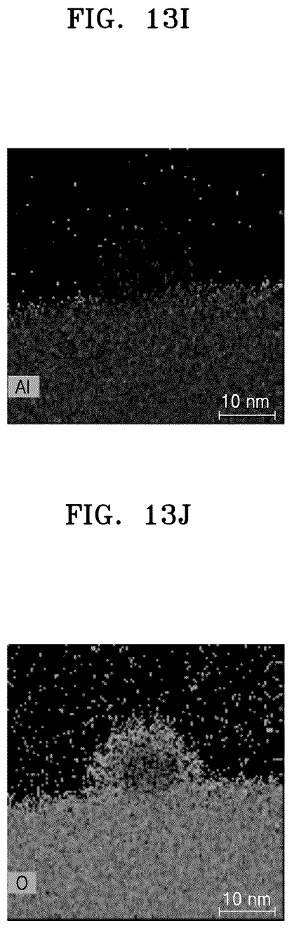

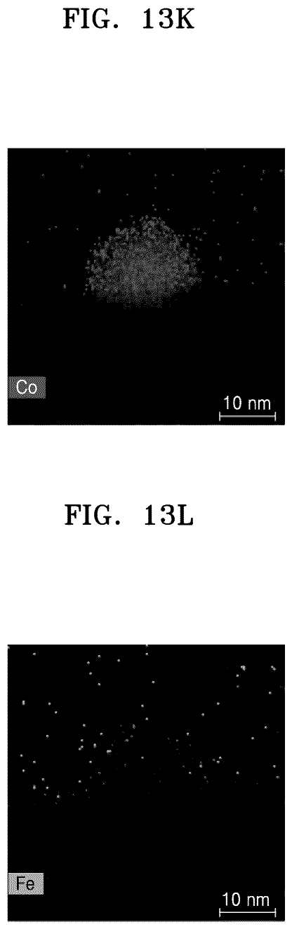

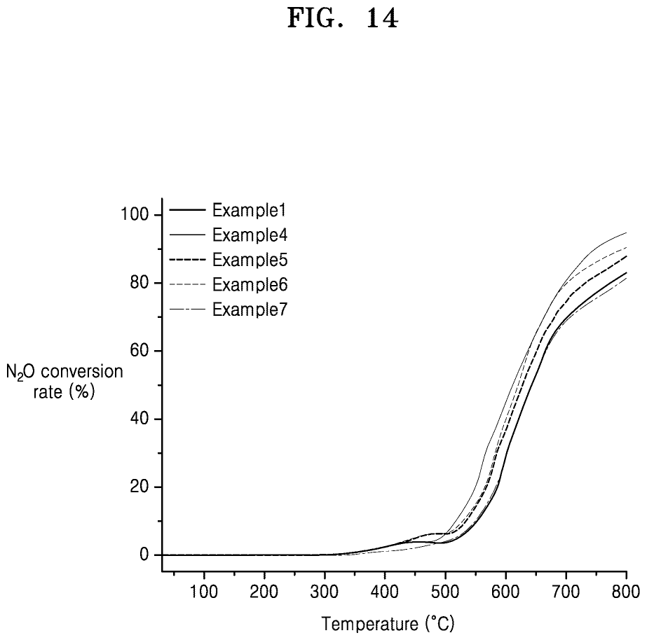

In addition, the TEM-EDS analysis results for the gas decomposition catalyst LACF25 prepared according to Example 8 are shown in FIGS. 13A to 13F. In addition, the TEM-EDS analysis results for the gas decomposition catalyst LAC prepared according to Example 1 are shown in FIGS. 13G to 13L.

As shown in FIG. 11B, the Co—Fe alloy was well exsolved on the host (LaAlO₃). The exsolved particle has a socket particle shape, which is a structure embedded in the host (LaAlO₃), and a coating layer (shell) containing Co—Fe alloy oxide is formed on the surface of the exsolved particle (core). The composition of the exsolved nanoparticles depends on the concentration of a dopant. As shown in FIG. 11B, the coating layer containing Co—Fe alloy oxide has a thickness of about 2 nm.

Referring to FIGS. 13A to 13F, it was found that the gas decomposition catalyst LACF25 prepared according to Example 8 existed in the form of nanoparticles in which a Co—Fe alloy was well exsolved, as compared with the gas decomposition catalyst LAC of Example 1 shown in FIGS. 13G to 13L.

### Evaluation Example 10: N₂O Decomposition Performance Evaluation (II)

In order to evaluate the nitrous oxide (N₂O) gas decomposition performance of the gas decomposition catalysts prepared in Example 1 and Examples 4 to 7 with respect to temperature, a nitrous oxide (N₂O) gas decomposition system shown in FIG. 16 to be described later was manufactured. The results thereof are shown in FIG. 14. Here, the heating rate is 4° C./min.

Specifically, the nitrous oxide (N₂O) gas decomposition system according to FIG. 16 is the same as that described in Evaluation Example 3.

The N₂O decomposition performance of each gas decomposition catalyst was evaluated by putting the content of nitrous oxide (N₂O) converted according to temperature using the nitrous oxide (N₂O) gas decomposition system according to FIG. 16 into Equation 1 above. The evaluation results are shown in FIG. 14. FIG. 14 shows the conversion rates of nitrous oxide (N₂O) of gas decomposition catalysts prepared by heat treatment under reducing conditions, at 700° C.

Referring to FIG. 14, it can be confirmed that all of the gas decomposition catalysts prepared in Examples 1 and 4 to 7 have an increase in the conversion rate of nitrous oxide (N₂O) as the operating temperature of the scrubber system increases from 300° C. to 800° C.

From this, it can be confirmed that the N₂O decomposition performance of all of the perovskite oxide gas decomposition catalysts prepared in Example 1 and Examples 4 to 7 increases as the operating temperature of the scrubber system increases.

### Evaluation Example 11: N₂O Decomposition Performance Evaluation (III)

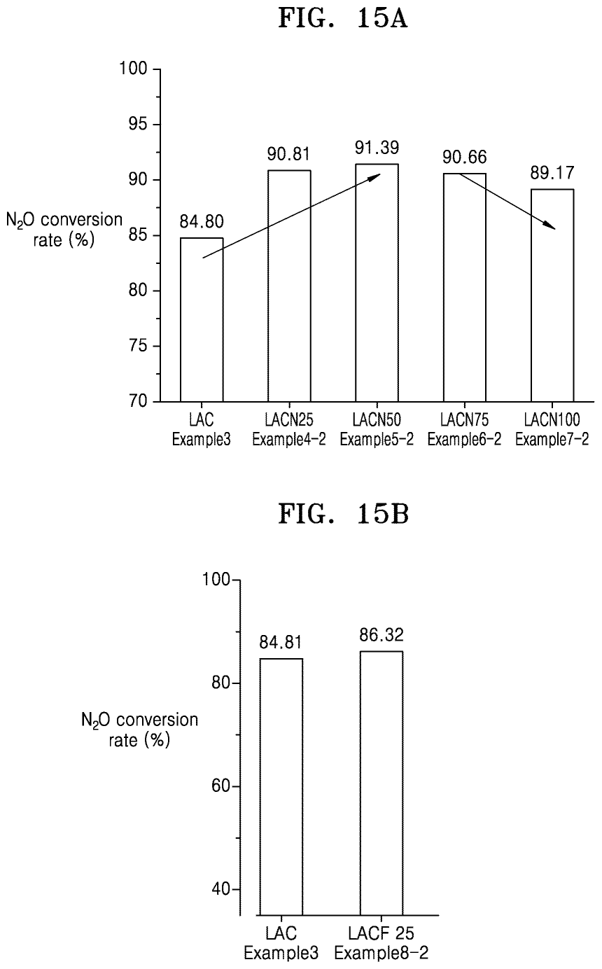

In order to evaluate the nitrous oxide (N₂O) gas decomposition performance of the gas decomposition catalysts prepared in Example 3, Example 4-2, Example 5-2, Example 6-2, and Example 7-2, a nitrous oxide (N₂O) gas decomposition system shown in FIG. 16 was manufactured. The results at a temperature of 800° C. are shown in FIG. 15A. Here, the heating rate (Ramp T) is 4° C./min.

The nitrous oxide (N₂O) gas decomposition system according to FIG. 16 is the same as that described in Evaluation Example 3.

The N₂O decomposition performance of each gas decomposition catalyst was evaluated using the nitrous oxide (N₂O) gas decomposition system shown in FIG. 16. The evaluation results are shown in FIG. 15A. The weight hourly space velocity (WHSV) of the nitrous oxide (N₂O) gas decomposition system is about 90,000 mL g (cat)⁻¹ h⁻¹.

The gas decomposition catalysts of Examples 3, 4-2, 5-2, 6-2, and 7-2 were prepared by heat treatment at 900° C. under reducing conditions. Referring to FIG. 15A, it can be confirmed that the nitrous oxide (N₂O) conversion rate increases. From this, it can be confirmed that all of the gas decomposition catalysts prepared in Examples 3, 4-2, 5-1, 6-2, and 7-2 have increased N₂O decomposition performance.

In particular, the gas decomposition efficiency of Examples 4-2, 5-2, 6-2, and 7-2 further increased as compared with that of the gas decomposition catalyst of Example 3. From this, it can be found that the N₂O decomposition performance of the gas decomposition catalyst including Co—Ni alloy exsolved particles or the gas decomposition catalyst including Ni exsolved particles was superior to that of the gas decomposition catalyst including Co exsolved particles.

### Evaluation Example 12: N₂O Decomposition Performance Evaluation (IV)

In order to evaluate the nitrous oxide (N₂O) gas decomposition performance of the gas decomposition catalysts LAC of Example 3 and the gas decomposition catalyst LACF25 of Example 8-2, a nitrous oxide (N₂O) gas decomposition system shown in FIG. 16 was manufactured. Here, the heating rate is 4° C./min.

The nitrous oxide (N₂O) gas decomposition system according to FIG. 16 is the same as that described in Evaluation Example 3.

The N₂O decomposition performance of each gas decomposition catalyst was evaluated using the nitrous oxide (N₂O) gas decomposition system shown in FIG. 16. When the gas decomposition catalyst LAC of Example 3 and the gas decomposition catalyst LACF25 of Example 8-2 were used, the evaluation results at an operating temperature of 800° C. are shown in FIG. 15B.

All of the gas decomposition catalysts of Example 3 and Example 8-2 were prepared by heat treatment at 900° C. under reducing conditions

As shown in FIG. 15B, it can be confirmed that the gas decomposition catalysts prepared in Example 3 and Example 8-2 have excellent nitrous oxide (N₂O) conversion rates of 84.81% and 86.32%, respectively, and thus the N₂O decomposition performance thereof increases.

A gas decomposition catalyst according to an aspect is thermally and chemically stable under the operating environment of nitrous oxide (N₂O) decomposition and has improved nitrous oxide (N₂O) decomposition performance.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A gas decomposition catalyst comprising:
a perovskite oxide host material containing a B′ element and represented by Formula 1; and
at least one B′ element protruding particle derived from some or all of the B′ element,
wherein the B′ element protruding particle has a shape in which a portion of the particle is fixed inside the perovskite oxide host material and another portion of the particle protrudes from the surface of the perovskite oxide host material: 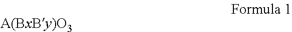
wherein, in Formula 1, A comprises lanthanum, strontium, or a combination thereof,
B comprises a transition metal having an oxidation number of +3, +4, or +5,
B′ comprises an element having a Gibbs free energy of 0 or less for a reduction reaction at 900° C. according to Reaction Formula 1, and
$$0 < x < 1 , 0 < y < 1 , and x + y = 1 :$$ 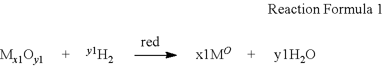
wherein, in Reaction Formula 1, x1 and y1 are each a positive rational number, “red” refers to the reduction reaction, and M is a metal.

2. The gas decomposition catalyst of claim 1,
wherein B comprises at least one of aluminum, titanium, iron, chromium, niobium, molybdenum, barium, or tantalum.

3. The gas decomposition catalyst of claim 1,
wherein B′ is selected differently from B, and B′ is at least one of cobalt, nickel, iron, copper, manganese, rhodium, palladium, iridium, platinum, or gold.

4. The gas decomposition catalyst of claim 1,
wherein the B′ element protruding particle comprises cobalt, nickel, a cobalt-nickel alloy, a cobalt-iron alloy, or a combination thereof,
the cobalt-nickel alloy is a compound represented by Co_{y1}Ni_{y2}, the cobalt-iron alloy is a compound represented by Co_{y1}Fe_{y2}, wherein 0< (y1+y2)≤0.5, 0<y1≤0.5, and 0<y2<0.5.

5. The gas decomposition catalyst of claim 1,
wherein, in Formula 1, 0.5≤x<1, 0<y≤0.5, and x+y=1.

6. The gas decomposition catalyst of claim 1,
wherein the perovskite oxide host material of Formula 1 comprises a compound represented by Formula 2: 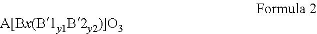
wherein, in Formula 2, A is lanthanum,
B is aluminum,
B′1 is cobalt,
B′2 is at least one of nickel, iron, copper, manganese, rhodium, palladium, iridium, platinum, or gold, and
$$0.5 \leq x < 1 , 0 < ( y 1 + y 2 ) \leq 0 \text{.5} ,$$
$$0 \leq y 1 \leq 0.5 , 0 \leq y 2 \leq 0.5 , x + y 1 + y 2 = 1 ,$$
provided that both y1 and y2 are not 0, and both y1 and y2 are not 0.5.

7. The gas decomposition catalyst of claim 1,
wherein the B′ element protruding particle has a socket shape, spherical shape, an elliptical shape, a ring shape, or a cylindrical shape, and
the B′ element protruding particle has a size of about 5 nanometers to about 50 nanometers.

8. The gas decomposition catalyst of claim 1,
wherein the B′ element protruding particles are present at a density of about 25 per square micrometers to about 1,000 per square micrometers.

9. The gas decomposition catalyst of claim 1,
wherein a coating layer containing a B′ element oxide is disposed on a surface of the B′ element protruding particle.

10. The gas decomposition catalyst of claim 9,
wherein a volume of the B′ element protruding particles per area of the coating layer containing the B′ element oxide is about 0.1 cubic nanometers per square nanometers to about 1.0 cubic nanometers per square nanometers.

11. The gas decomposition catalyst of claim 1,
wherein the B′ element protruding particle is a nanoparticle formed by exsolution from the inside of the perovskite oxide host material onto the surface of the perovskite oxide host material.

12. A method of decomposing a nitrous oxide gas, the method comprising:
contacting a gas comprising nitrous oxide with a gas decomposition catalyst to decompose the nitrous oxide gas,
wherein the gas decomposition catalyst comprises: a perovskite oxide host material containing a B′ element and represented by Formula 1; and
at least one B′ element protruding particle derived from some or all of the B′ element,
wherein the B′ element protruding particle has a shape in which a portion of the particle is fixed inside the perovskite oxide host material and another portion of the particle protrudes from the surface of the perovskite oxide host material: 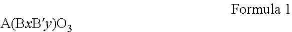
wherein, in Formula I, A comprises lanthanum, strontium, or a combination thereof,
B comprises a transition metal having an oxidation number of +3, +4, or +5,
B′ comprises an element having a Gibbs free energy of 0 or less for a reduction reaction at 900° C. according to Reaction Formula 1, and
$$0 < x < 1 , 0 < y < 1 , and x + y = 1 :$$ 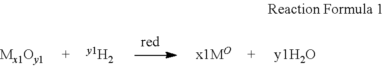
wherein, in Reaction Formula 1, x1 and y1 are each a positive rational number, “red” refers to the reduction reaction, and M is a metal.

13. The method of claim 12,
wherein B comprises at least one of aluminum, titanium, iron, chromium, niobium, molybdenum, barium, or tantalum, and
B′ comprises at least one of cobalt, nickel, iron, copper, manganese, rhodium, palladium, iridium, platinum, or gold.

14. The method of claim 12,
wherein the B′ element protruding particle is a reduced particle formed by exsolution from the inside of the perovskite oxide host material onto the surface of the perovskite oxide host material.

15. The method of claim 12, wherein when the gas decomposition catalyst is subjected to reduction heat treatment at a temperature of 900° C. to form B′ element protruding particles on the surface of the perovskite oxide host material, a conversion rate of nitrous oxide with respect to the gas decomposition catalyst according to Equation 1 at an operating temperature of 800° C. is 80% or more:
$$Conversion rate of nitrous oxide = [ \text{} ( 1 - content ( moles per second ) of nitrous oxide gas discharged to outside of reactor at each temperature ) \text{} / content ( moles per second ) of nitrous oxide gas introduced into gas mixer at each temperature ] \times 100 \qquad Equation 1$$

16. A scrubber system for decomposing a nitrous oxide gas, the scrubber system comprising:
a gas inlet unit through which a gas comprising nitrous oxide is introduced;
a scrubber comprising a gas decomposition catalyst for decomposing nitrous oxide from the gas comprising nitrous oxide introduced from the gas inlet unit to provide a scrubbed gas; and
a gas outlet unit for discharging the scrubbed gas,
wherein the gas decomposition catalyst comprises: a perovskite oxide host material containing a B′ element and represented by Formula 1; and at least one B′ element protruding particle derived from some or all of the B′ element,
wherein the B′ element protruding particle has a shape in which a portion of the particle is fixed inside the perovskite oxide host material and another portion of the particle protrudes from the surface of the perovskite oxide host material: 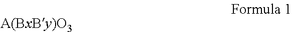
wherein, in Formula I, A comprises lanthanum, strontium, or a combination thereof,
B comprises a transition metal having an oxidation number of +3, +4, or +5,
B′ comprises an element having a Gibbs free energy of 0 or less for a reduction reaction at 900° C. according to Reaction Formula 1, and
$$0 < x < 1 , 0 < y < 1 , and x + y = 1 :$$ 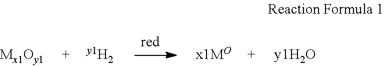
wherein, in Reaction Formula 1, x1 and y1 are each a positive rational number, “red” refers to the reduction reaction, and
M is a metal.

17. The scrubber system of claim 16,
wherein the scrubber comprises:
at least one reactor including a combustion chamber in which the gas comprising nitrous oxide is introduced from the gas inlet unit and heated;
a catalyst chamber in which the gas comprising nitrous oxide heated from the combustion chamber is heated and introduced to react with a gas decomposition catalyst to decompose nitrous oxide gas; and
a heat storage chamber in which the gas comprising nitrous oxide that has reacted with the gas decomposition catalyst is introduced from the catalyst chamber.

18. The scrubber system of claim 17,
wherein the gas decomposition catalyst is disposed in the catalyst chamber in a bulk form, a molded form, or a layered bed form.

19. The scrubber system of claim 17,
the scrubber system has a structure in which two or more of the reactors are arranged in parallel.

20. The scrubber system of claim 16,
wherein the scrubber system has an operating temperature of about 300° C. to about 900° C., and
the scrubber system has a weight hourly space velocity of about 10,000 milliliter grams of substance per gram of catalytic unit per hour to about 500,000 milliliters of substance per gram of catalytic unit per hour.
